(19) United States
(12) Patent Application Publication
(10) Pub. No.: US 2011/0029413 A1
(43) Pub. Date: Feb. 3, 2011

(54) PERISHABLE LIFETIME MANAGEMENT SYSTEM AND METHOD

(76) Inventors: Israel Ben-Tzur, Kfar Veredim (IL); Gary Ward, Galil Elyon (IL)

Correspondence Address: LADAS & PARRY LLP, 224 SOUTH MICHIGAN AVENUE, SUITE 1600, CHICAGO, IL, 60604, US

(21) Appl. No.: 12/865,232

(22) PCT Filed: Jan. 29, 2009
(86) PCT No.: PCT/IL09/00116

§ 371 Date: Sep. 21, 2010

Related U.S. Application Data
(60) Provisional application No. 61/024,944, filed on Jan. 31, 2008.
(60) Provisional application No. 61/201,036, filed on Dec. 4, 2008.

(51) Int. Cl. G06Q 10/00

(52) U.S. Cl. 705/28

(57) ABSTRACT

A system for managing perishables in a supply chain, including at least one sensor module adapted to sense at least one parameter of at least one monitorable shipping unit of perishables through multiple stages in a supply chain, a plurality of sensed inputs integrator and communicators (SIICs), each communicating with the least one sensor module at least one different one of the multiple stages in the supply chain, for receiving information relating to the at least one parameter, a perishable lifecycle manager (PLM) communicating with at least some of the plurality of SIICs and a user interface providing to a user an indication of at least one of remaining lifetime prediction, supply chain link accountability and first expired, first out logistics outputs relating to the at least one monitorable shipping unit of perishables whose at least one parameter is sensed by the at least one sensor module.

### REFERENCE TO RELATED APPLICATIONS

Reference is hereby made to U.S. Provisional Patent Application Serial No. 61/024,944, entitled OVERVIEW OF THE XSENSE SYSTEM, filed Jan. 31, 2008, and to U.S. Provisional Patent Application Ser. No. 61/201,036, entitled XSENSE SYSTEM, filed Dec. 4, 2008, the disclosures of which are hereby incorporated by reference and priority of which is hereby claimed pursuant to 37 CFR 1.78(a) (4) and (5)(i).

Reference is also hereby made to the following patents and published patent applications, the disclosures of which are hereby incorporated by reference:

U.S. Pat. Nos. 6,190,710 and 6,740,346; and

Published PCT Patent Application No. WO 2004/107770.

### FIELD OF THE INVENTION

The present invention relates to real-time sensed inputs integration and communication as applicable to logistics of perishable items.

### BACKGROUND OF THE INVENTION

The following publications are believed to represent the current state of the art:

U.S. Pat. Nos. 6,972,682 and 6,549,135; and

Published U.S. Patent Application Publication No. 2005/0065682.

### SUMMARY OF THE INVENTION

The present invention seeks to provide improved real-time sensed inputs integration and communication as applicable to logistics of perishable items.

There is thus provided in accordance with a preferred embodiment of the present invention a system for managing perishables in a supply chain, the system including at least one sensor module adapted to sense at least one parameter of at least one monitorable shipping unit of perishables through multiple stages in a supply chain, a plurality of sensed inputs integrator and communicators (SIICs), each communicating with the least one sensor module at at least one different one of the multiple stages in the supply chain, for receiving information relating to the at least one parameter, a perishable lifecycle manager (PLM) communicating with at least some of the plurality of SIICs and including at least one of remaining lifetime prediction functionality, supply chain link accountability functionality and first expired, first out logistics functionality operating using at least one parameter of at least one monitorable shipping unit of perishables through the multiple stages in the supply chain and a user interface providing to a user an indication of at least one of remaining lifetime prediction, supply chain link accountability and first expired, first out logistics outputs relating to the at least one monitorable shipping unit of perishables whose the at least one parameter is sensed by the at least one sensor module.

In a preferred embodiment of the present invention the perishables in the least one monitorable shipping unit of perishables are packed in modified atmosphere packaging and the user interface provides to the user an indication of remaining lifetime prediction for the perishables which prediction is based on their being packed in the modified atmosphere packaging.

There is also provided in accordance with another preferred embodiment of the present invention a system for managing perishables in a supply chain, the system including at least one sensor module adapted to sense at least one parameter of at least one monitorable shipping unit of perishables packed in modified atmosphere packaging through multiple stages in a supply chain, the at least one parameter having enhanced importance for perishables packed in modified atmosphere packaging; a plurality of sensed inputs integrator and communicators (SIICs), each communicating with the least one sensor module at at least one different one of the multiple stages in the supply chain, for receiving information relating to the at least one parameter; a perishable lifecycle manager (PLM) communicating with at least some of the plurality of SIICs and including at least one of remaining lifetime prediction functionality, supply chain link accountability functionality and first expired, first out logistics functionality operating using at least one parameter of at least one monitorable shipping unit of perishables through the multiple stages in the supply chain and a user interface providing to a user an indication of at least one of remaining lifetime prediction, supply chain link accountability and first expired, first out logistics outputs relating to the at least one monitorable shipping unit of perishables whose the at least one parameter is sensed by the at least one sensor module.

Preferably, the user interface distinguishes between monitorable shipping units which are in transit and monitorable shipping units which are being stored in a warehouse. Additionally or alternatively, the user interface provides a near real time alert of exceedence by the at least one parameter of at least one threshold. Alternatively or additionally, the user interface provides a near real time alert when a predicted remaining lifetime of the perishable falls below a threshold.

In accordance with a preferred embodiment of the present invention the system for managing perishables in a supply chain also includes a location indicator indicating the location of the at least one monitorable shipping unit of perishables.

Preferably, the user interface provides a near real time alert when a predicted remaining lifetime of the perishable falls below expected remaining transport time.

There is further provided in accordance with yet another preferred embodiment of the present invention a system for managing perishables in a supply chain, the system including at least one sensor module adapted to sense at least one parameter of at least one monitorable shipping unit of perishables through multiple stages in a supply chain; a plurality of sensed inputs integrator and communicators (SIICs), each communicating with the least one sensor module at at least one different one of the multiple stages in the supply chain, for receiving information relating to the at least one parameter and an at least near real time alert interface providing to a user an at least near real time alert of the occurrence of an event, indicated by the at least one sensor modules which is expected to impact on at least one of remaining lifetime prediction, supply chain link accountability and first expired, first out logistics.

In accordance with a preferred embodiment of the present invention the perishables in the least one monitorable shipping unit of perishables are packed in modified atmosphere packaging and the at least near real time alert interface provides to the user an indication of remaining lifetime prediction for the perishables which prediction is based on their being packed in the modified atmosphere packaging. Additionally or alternatively, the at least near real time alert interface distinguishes between monitorable shipping units which are in transit and monitorable shipping units which are being stored in a warehouse.

There is even further provided in accordance with still another preferred embodiment of the present invention a system for managing perishables in a supply chain, the system including at least one sensor module adapted to sense at least one parameter of at least one monitorable shipping unit of perishables packed in modified atmosphere packaging through multiple stages in a supply chain, the at least one parameter having enhanced importance for perishables packed in modified atmosphere packaging, a plurality of sensed inputs integrator and communicators (SIICs), each communicating with the least one sensor module at at least one different one of the multiple stages in the supply chain, for receiving information relating to the at least one parameter and an at least near real time alert interface providing to a user an at least near real time alert of the occurrence of an event, indicated by the at least one sensor modules which is expected to impact on at least one of remaining lifetime prediction, supply chain link accountability and first expired, first out logistics.

Preferably, the system for managing perishables in a supply chain also includes temperature mapping functionality communicating with at least one of the plurality of SIICs and being operative to ascertain variations in temperature of the perishables within a volume containing multiple perishables and multiple ones of the plurality of sensor modules based on the information relating to the parameters.

In accordance with a preferred embodiment of the present invention the at least one monitorable shipping unit includes a multiplicity of monitorable shipping units.

Preferably, the at least one parameter is temperature. Alternatively, the at least one parameter is relative humidity. Additionally or alternatively, the at least one parameter includes multiple parameters.

In accordance with a preferred embodiment of the present invention the plurality of SIICs each provide an output indication of the possible presence of at least one pathogen. Additionally or alternatively, the plurality of SIICs each provide an output indication of the possible presence of at least one of ethylene, ethanol, oxygen and CO₂.

There is also provided in accordance with another preferred embodiment of the present invention a system for managing perishables in a supply chain, the system including a plurality of sensor modules adapted to sense parameters of perishables in a supply chain which indicate the presence of pathogens, at least one sensed inputs integrator and communicator (SIIC), communicating with the plurality of sensor modules, for receiving information relating to the parameters and an at least near real time alert interface providing to a user an at least near real time alert of the presence or expectation of the presence of at least a predetermined amount of the pathogens in a perishable whose parameters are sensed by at least one of the plurality of sensor modules.

There is yet further provided in accordance with still another preferred embodiment of the present invention a system for managing perishables in a supply chain, the system including a plurality of sensor modules adapted to sense parameters of at least one of temperature, relative humidity, ethylene, oxygen and CO₂ within modified atmosphere packaging containing perishables, at least one sensed inputs integrator and communicator (SIIC), communicating with the plurality of sensor modules, for receiving information relating to the at least one of temperature, relative humidity, ethylene, oxygen and CO₂ parameters and an at least near real time alert interface providing to a user an at least near real time alert of the occurrence of exceedance of a threshold of at least one of temperature, relative humidity, ethylene, oxygen and CO₂, indicated by at least one of the plurality of sensor modules.

Preferably, the at least one sensor module measures the at least one parameter inside the modified atmosphere packaging. Additionally, the at least one sensor module measures the at least one parameter inside the perishable. Alternatively, the at least one sensor module measures the at least one parameter outside of the perishable.

In accordance with a preferred embodiment of the present invention the at least one sensor module includes a visually sensible sensor module identifier. Additionally or alternatively, the at least one sensor module communicates a time stamp related to the at least one parameter to the SIIC.

Preferably, the at least one sensor module includes at least one of a temperature sensor, a relative humidity sensor, an O₂ sensor, a CO₂ sensor, a C₂H₄ sensor, a C₂H₅OH sensor, a pathogen sensor and a light sensor. Additionally or alternatively, the at least one sensor module also includes a GPS antenna

In accordance with a preferred embodiment of the present invention each of the plurality of SIICs includes at least one of an RF transceiver coupled to an antenna, a GPS receiver associated with a GPS antenna, a cellular communications modem associated with an antenna, a LAN interface and a satellite communications modem associated with an antenna. Additionally or alternatively, each of the plurality of SIICs includes a memory operative to store data received from at least one of the at least one sensor modules.

Preferably, each of the plurality of SIICs communicates with external sensors including at least one of an ambient temperature sensor, an ambient pressure sensor, a relative humidity sensor, at least one gas sensor, pH sensor, a door opening sensor, an open/closed vent sensor, a light sensor; a refrigeration unit status sensor; a vehicle engine status sensor, a vehicle battery charging sensor, a refrigerated container battery charging sensor, a humidifier status sensor, a dehumidifier status sensor and an ozone generator status sensor. Additionally, the at least one gas sensor includes at least one of an O₂ sensor, a CO₂ sensor, an ethanol sensor and a methyl bromide sensor.

In accordance with a preferred embodiment of the present invention the plurality of SIICs includes at least one fired position SIIC and at least one variable position SIIC. Additionally or alternatively, the user interface is operative to provide access to different system information to different system users.

Preferably, the PLM is operative to provide an advance notification of impending arrival of distressed perishables.

There is also provided in accordance with another preferred embodiment of the present invention a method for managing perishables in a supply chain, the method including sensing at least one parameter of at least one monitorable shipping unit of perishables through multiple stages in a supply chain, employing a plurality of sensed inputs integrator and communicators (SIICs), each communicating with at least one sensor module at at least one different one of the multiple stages in the supply chain, for receiving information relating to the at least one parameter, communicating with at least some of the plurality of SIICs and producing, based on information received therefrom, at least one of remaining lifetime predictions, supply chain link accountability information and first expired, first out logistics information through multiple stages in the supply chain and providing to a user at least one of remaining lifetime prediction, supply chain link accountability information and first expired, first out logistics outputs relating to the at least one monitorable shipping unit of perishables whose the at least one parameter is sensed by the at least one sensor module.

Preferably, the perishables in the least one monitorable shipping unit of perishables are packed in modified atmosphere packaging and the providing to a user includes providing an indication of remaining lifetime prediction for the perishables based on their being packed in the modified atmosphere packaging.

There is further provided in accordance with still another preferred embodiment of the present invention a method for managing perishables in a supply chain, the method including sensing at least one parameter of at least one monitorable shipping unit of perishables packed in modified atmosphere packaging through multiple stages in a supply chain, the at least one parameter having enhanced importance for perishables packed in modified atmosphere packaging, employing a plurality of sensed inputs integrator and communicators (SIICs), each communicating with at least one sensor module at at least one different one of the multiple stages in the supply chain, for receiving information relating to the at least one parameter, communicating with at least some of the plurality of SIICs and producing, based on information received therefrom, at least one of remaining lifetime predictions, supply chain link accountability information and first expired, first out logistics information through multiple stages in the supply chain and providing to a user at least one of remaining lifetime prediction, supply chain link accountability information and first expired, first out logistics outputs relating to the at least one monitorable shipping unit of perishables whose the at least one parameter is sensed by the at least one sensor module.

In accordance with a preferred embodiment of the present invention the providing to a user includes distinguishing between monitorable shipping units which are in transit and monitorable shipping units which are being stored in a warehouse.

Preferably, the method for managing perishables in a supply chain also includes providing a near real time alert of exceedence by the at least one parameter of at least one threshold. Additionally or alternatively, the method for managing perishables in a supply chain also includes providing a near real time alert when a predicted remaining lifetime of the perishable falls below a threshold.

In accordance with a preferred embodiment of the present invention the method for managing perishables in a supply chain also includes monitoring the location of the at least one monitorable shipping unit of perishables.

Preferably, the method for managing perishables in a supply chain also includes providing a near real time alert when a predicted remaining lifetime of the perishable falls below expected remaining transport time.

There is still further provided in accordance with even another preferred embodiment of the present invention a method for managing perishables in a supply chain, the method including sensing at least one parameter of at least one monitorable shipping unit of perishables through multiple stages in a supply chain, employing a plurality of sensed inputs integrator and communicators (SIICs), each communicating with at least one sensor module at at least one different one of the multiple stages in the supply chain, for receiving information relating to the at least one parameter and providing to a user an at least near real time alert of the occurrence of an event, indicated by the sensing, which is expected to impact on at least one of remaining lifetime prediction, supply chain link accountability and first expired, first out logistics.

Preferably, the perishables in the least one monitorable shipping unit of perishables are packed in modified atmosphere packaging and the providing to a user includes providing an indication of remaining lifetime prediction for the perishables based on their being packed in the modified atmosphere packaging. Additionally or alternatively, the providing to a user includes distinguishing between monitorable shipping units which are in transit and monitorable shipping units which are being stored in a warehouse.

There is even further provided in accordance with yet another preferred embodiment of the present invention a method for managing perishables in a supply chain, the method including sensing at least one parameter of at least one monitorable shipping unit of perishables packed in modified atmosphere packaging through multiple stages in a supply chain, the at least one parameter having enhanced importance for perishables packed in modified atmosphere packaging, employing a plurality of sensed inputs integrator and communicators (SIICs), each communicating with at least one sensor module at at least one different one of the multiple stages in the supply chain, for receiving information relating to the at least one parameter and providing to a user an at least near real time alert of the occurrence of an event, indicated by the sensing, which is expected to impact on at least one of remaining lifetime prediction, supply chain link accountability and first expired, first out logistics.

In accordance with a preferred embodiment of the present invention the method for managing perishables in a supply chain also includes communicating with at least one of the plurality of SIICs and ascertaining variations in temperature of the perishables within a volume containing multiple perishables and multiple ones of the plurality of sensor modules based on the information relating to the parameters.

Preferably, the at least one monitorable shipping unit includes a multiplicity of monitorable shipping units.

In accordance with a preferred embodiment of the present invention the at least one parameter is temperature. Alternatively, the at least one parameter is relative humidity. Additionally or alternatively, the at least one parameter includes multiple parameters.

Preferably, the method for managing perishables in a supply chain also includes providing an output indication of the possible presence of at least one pathogen. Additionally or alternatively, the method for managing perishables in a supply chain also includes providing an output indication of the possible presence of at least one of ethylene, ethanol, oxygen and CO₂.

There is also provided in accordance with still another preferred embodiment of the present invention a method for managing perishables in a supply chain, the method including sensing, with a plurality of sensor modules, parameters of perishables in a supply chain which indicate the presence of pathogens, employing a plurality of sensed inputs integrator and communicators (SIICs), receiving information relating to the parameters from the plurality of sensor modules and providing to a user an at least near real time alert of the presence or expectation of the presence of at least a predetermined amount of the pathogens in a perishable whose parameters are sensed by at least one of the plurality of sensor modules.

There is further provided in accordance with yet another preferred embodiment of the present invention a method for managing perishables in a supply chain, the method including sensing, with a plurality of sensor modules, parameters of at least one of temperature, relative humidity, ethylene, oxygen and CO₂ within modified atmosphere packaging containing perishables, employing a plurality of sensed inputs integrator and communicators (SIICs), receiving information relating to the at least one of temperature, relative humidity, ethylene, oxygen and CO₂ parameters from the plurality of sensor modules and providing to a user an at least near real time alert of the occurrence of exceedance of a threshold of at least one of temperature, relative humidity, ethylene, oxygen and CO₂, indicated by at least one of the plurality of sensor modules.

In accordance with a preferred embodiment of the present invention the method for managing perishables in a supply chain also includes measuring the at least one parameter inside the modified atmosphere packaging. Additionally or alternatively, the method for managing perishables in a supply chain also includes measuring the at least one parameter inside the perishable. Alternatively, the method for managing perishables in a supply chain also includes measuring the at least one parameter outside of the perishable.

Preferably, the at least one sensor module includes a visually sensible sensor module identifier.

In accordance with a preferred embodiment of the present invention the method for managing perishables in a supply chain also includes communicating a time stamp related to the at least one parameter to the SIIC.

In accordance with a preferred embodiment of the present invention the at least one parameter includes at least one of temperature, relative humidity, O₂ level, CO₂ level, C₂H₄ level, C₂H₅OH level, pathogen level and light level. Additionally or alternatively, the method for managing perishables in a supply chain also includes communicating a location of the monitorable shipping unit to the SIIC.

Preferably, each of the plurality of SIICs includes at least one of an RF transceiver coupled to an antenna, a GPS receiver associated with a GPS antenna, a cellular communications modem associated with an antenna, a LAN interface and a satellite communications modem associated with an antenna.

Preferably, the method for managing perishables in a supply chain also includes storing data received by the SIICs from at least one of the at least one sensor modules. Additionally or alternatively, the method for managing perishables in a supply chain also includes communicating to the plurality of SIICs at least one of ambient temperature, ambient pressure, relative humidity, at least one gas level, pH, a door open status, an open/closed vent status, a light level; a refrigeration unit status; a vehicle engine status, a vehicle battery charging status, a refrigerated container battery charging status, a humidifier status, a dehumidifier status and an ozone generator status. Additionally, the at least one gas level includes at least one of O₂ level, CO₂ level, ethanol level and methyl bromide level.

In accordance with a preferred embodiment of the present invention the plurality of SIICs includes at least one fixed position SIIC and at least one variable position SIIC.

Preferably, the method for managing perishables in a supply chain also includes providing access to different information for different users. Additionally or alternatively, the method for managing perishables in a supply chain also includes providing an advance notification of impending arrival of distressed perishables.

### BRIEF DESCRIPTION OF THE DRAWINGS

The present invention will be understood and appreciated more fully from the following detailed description, taken in conjunction with the drawings in which:

FIGS. 1A, 1B, 1C, 1D, 1E, 1F, 1G and 1H are simplified pictorial illustrations of a system and methodology for monitoring and logistics of perishable items in accordance with a preferred embodiment of the present invention;

FIGS. 2A, 2B and 2C, taken together, are a simplified functional flow chart of the operation of the system of FIGS. 1A-1H;

FIG. 3 is a simplified exploded view illustration of an embodiment of a sensing module employed in the system of FIGS. 1A-1H and 2A-2C;

FIGS. 4A, 4B and 4C are simplified pictorial illustrations of the sensing module of FIG. 3;

FIGS. 5A, 5B and 5C are simplified respective sectional illustrations taken along lines V-V in corresponding FIGS. 4A-4C;

FIG. 6 is a simplified illustration of a second embodiment of a sensing module employed in the system of FIGS. 1A-1H and 2A-2C;

FIG. 7 is a simplified illustration of a third embodiment of a sensing module employed in the system of FIGS. 1A-1H and 2A-2C;

FIG. 8 is a simplified illustration of a sensed inputs integrator and communicator (SIIC), various embodiments of which are employed in the system of FIGS. 1A-1H and 2A-2C:

FIGS. 9A-9C, taken together, are a simplified functional flow chart of the operation of the system of FIGS. 1A-1H employing the sensor of FIGS. 3-5C; and

FIGS. 10A-10G are simplified representations of reports produced by the system of FIGS. 1A-9C.

### DETAILED DESCRIPTION OF PREFERRED EMBODIMENTS

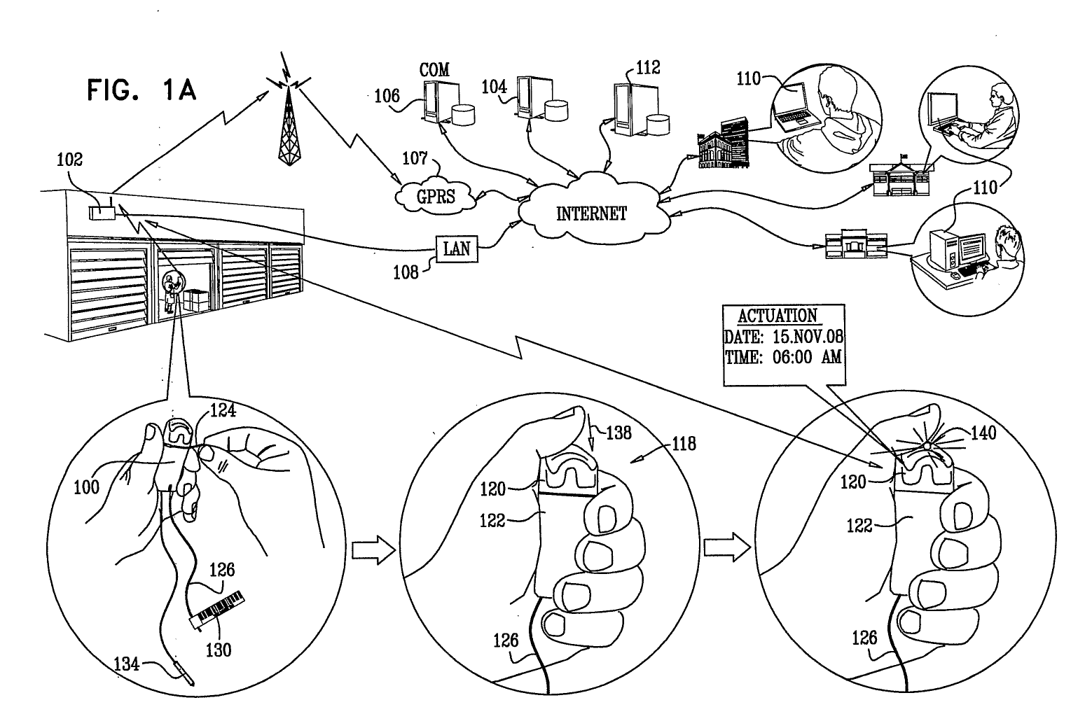

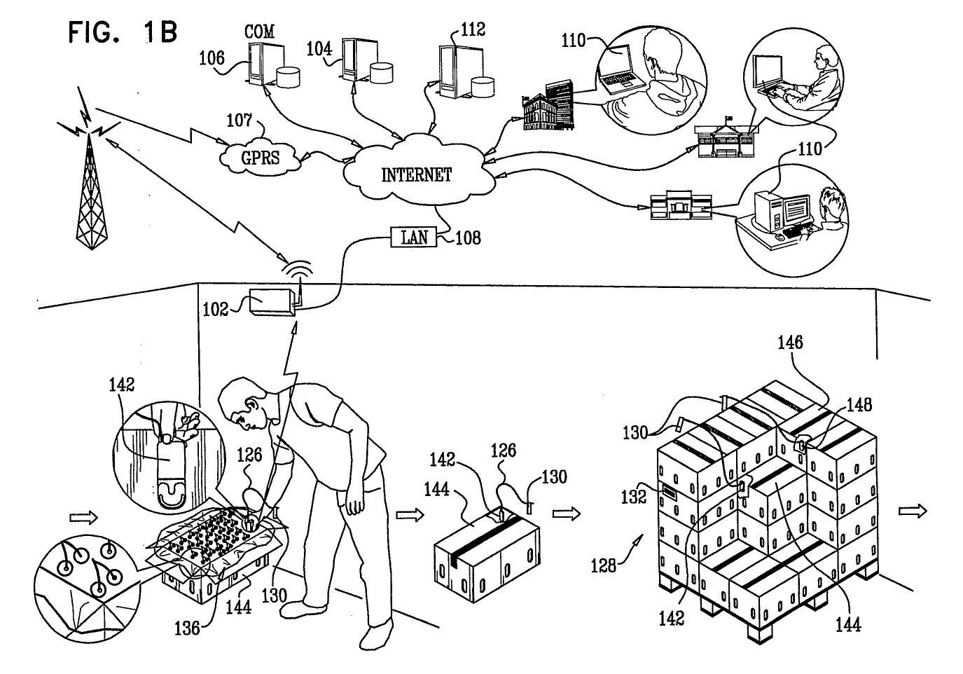

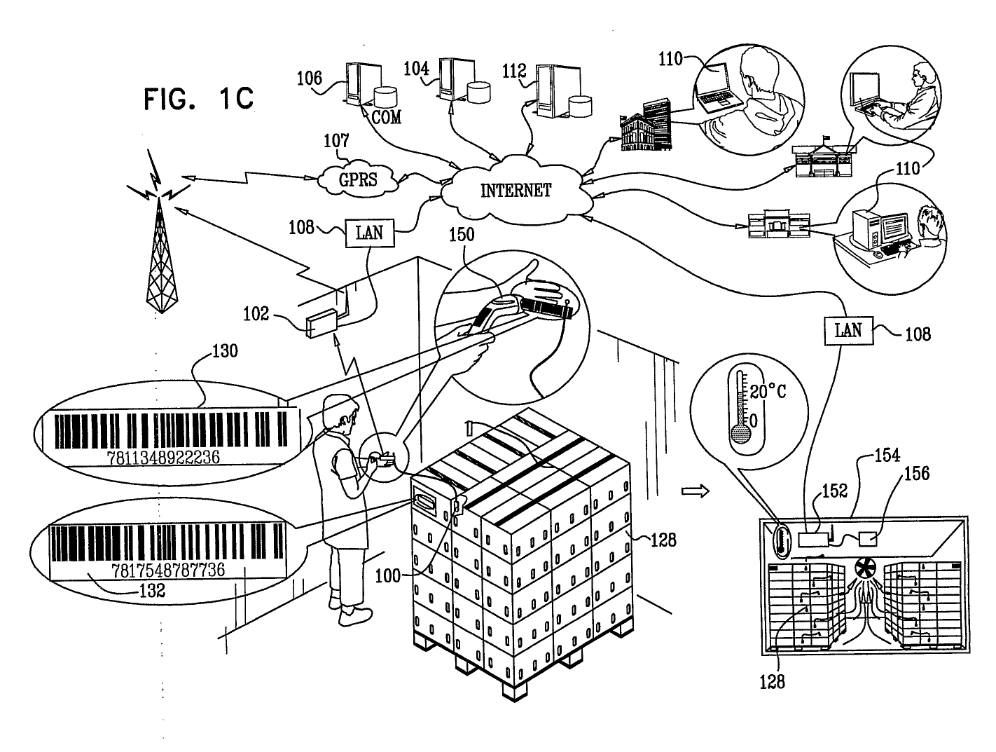

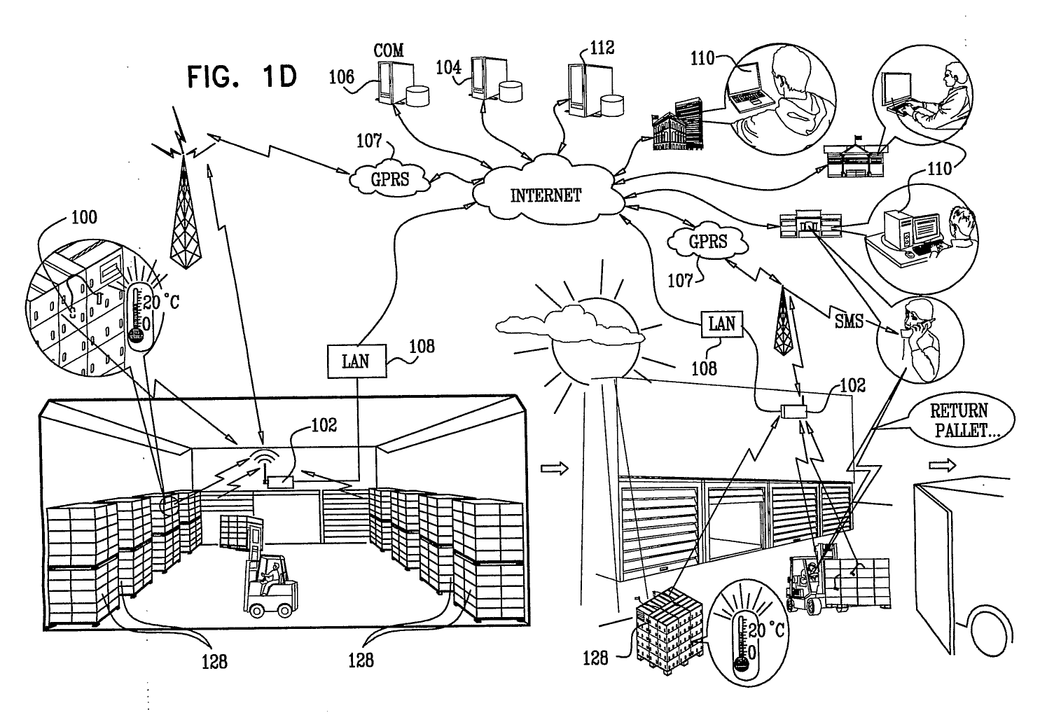

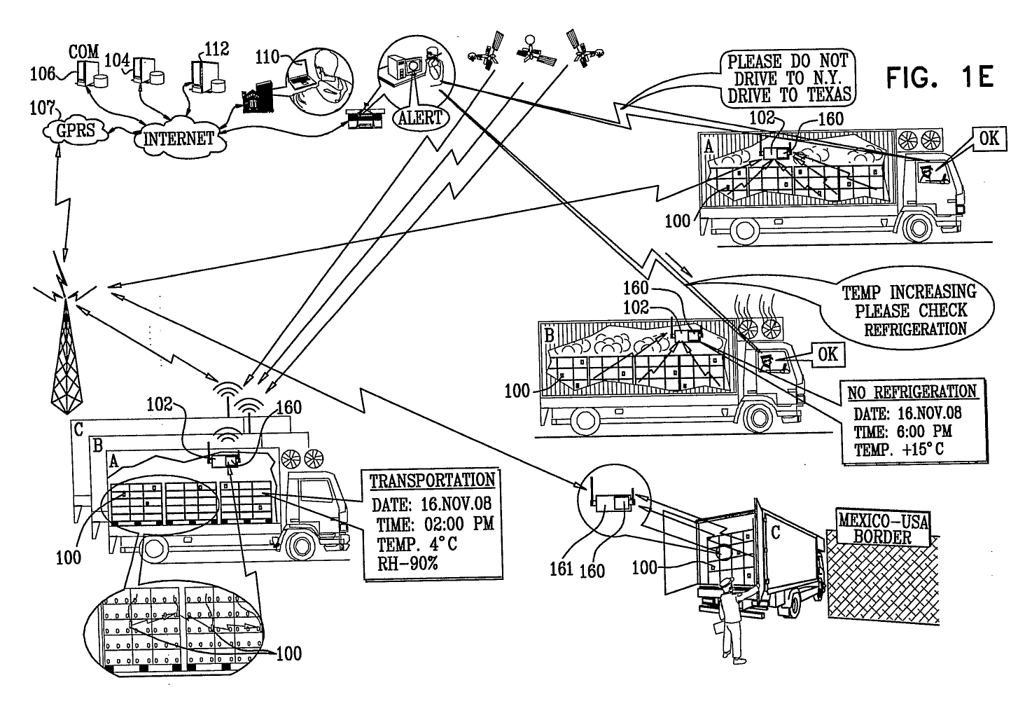

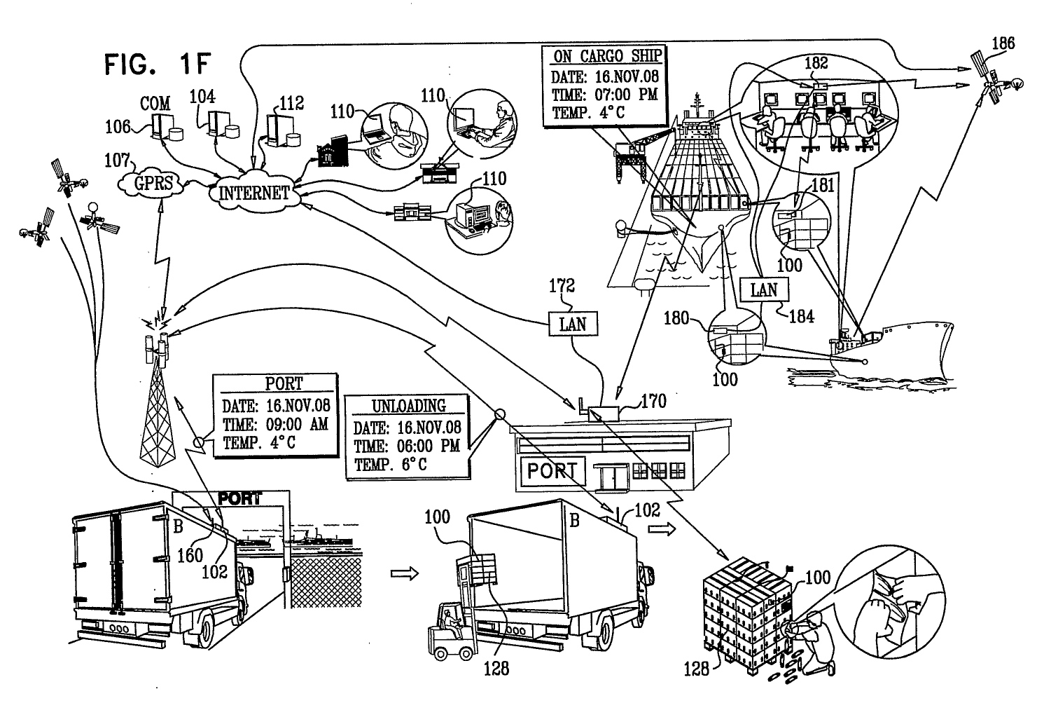

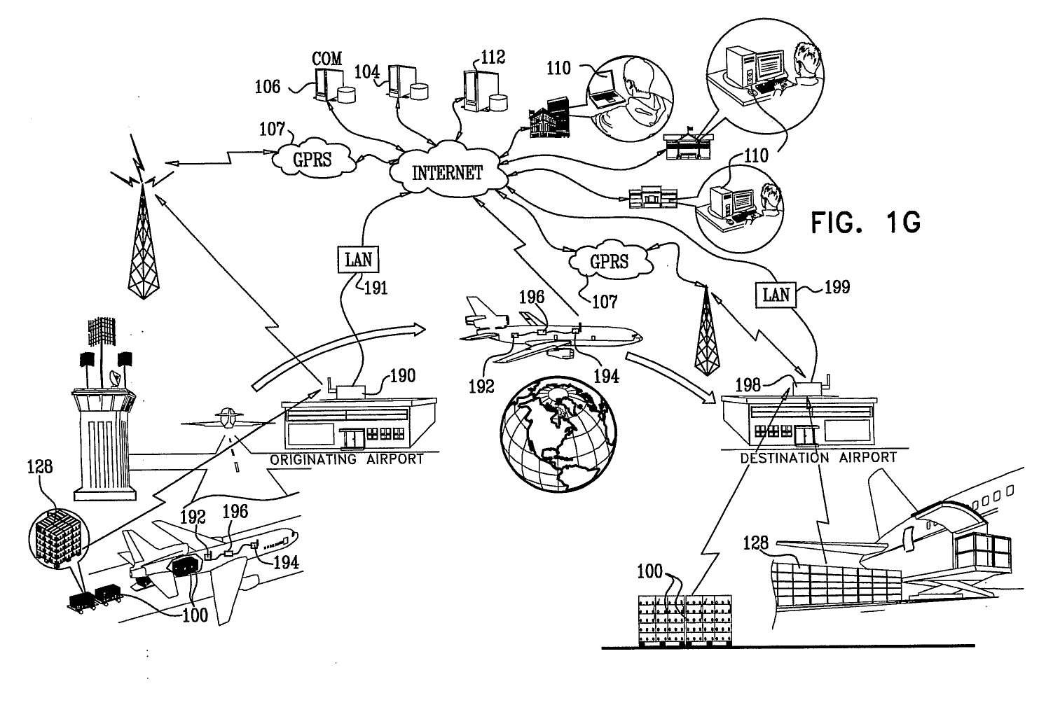

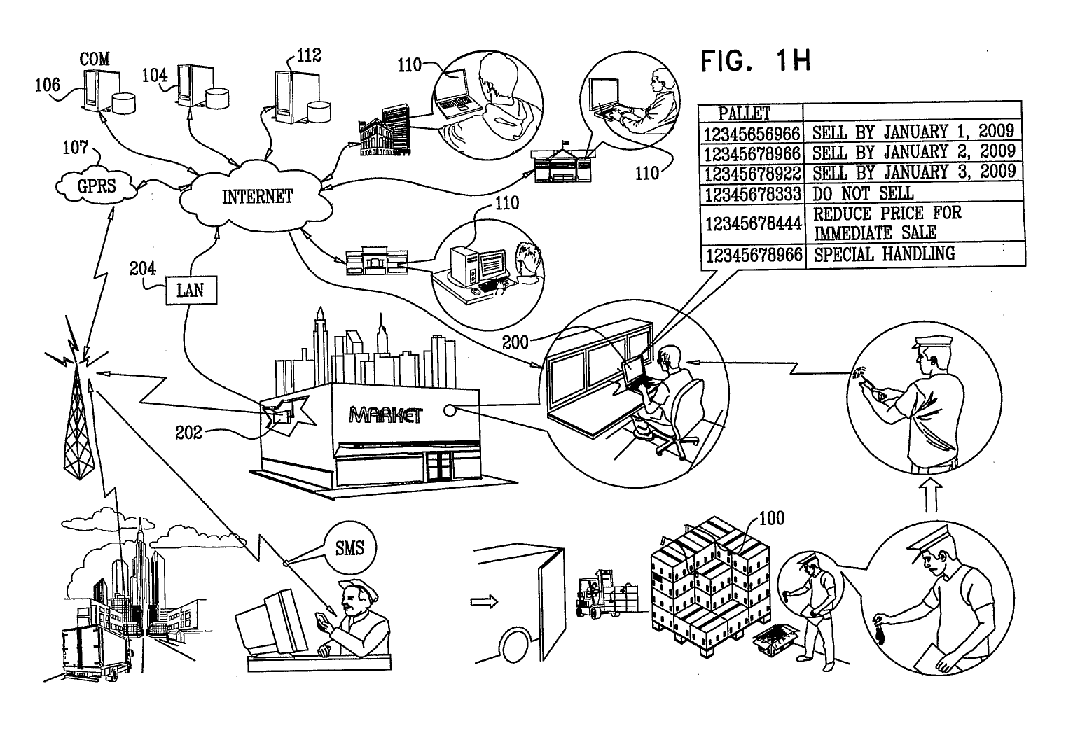

Reference is now made to FIGS. 1A, 1B, 1C, 1D, 1E, 1F, 1G and 1H which are simplified pictorial illustrations of a system and methodology for monitoring and logistics of perishable items in accordance with a preferred embodiment of the present invention.

As seen in FIG. 1A, there is seen part of a system for managing perishables in a supply chain including a plurality of sensor modules, such as sensor module 100, adapted to sense parameters of perishables, preferably fresh produce packaged in modified atmosphere packaging, in a supply chain and at least one sensed inputs integrator and communicator (SIIC) 102, communicating with a plurality of sensor modules 100, for receiving information relating to the parameters.

In the context of the present invention, the term “modified atmosphere packaging” is used to refer to any packaging in which the gas composition is modified in order to preserve the quality of the perishable. Examples of such perishables are fresh produce, meat, fish, seafood, milk, dairy products and drugs. Modified atmosphere packaging includes, but is not limited to, packaging which is flushed with a desired gas composition and equilibrium modified atmosphere packaging, in which a desired gas composition is obtained by natural respiration of fresh produce.

Modified atmosphere packaging suitable for fresh produce is described and claimed in U.S. Pat. No. 6,190,710 and is commercially available from Stepac Ltd. of Tefen, Israel under the brand name XTEND®.

Modified atmosphere packaging suitable for meat, fish, seafood and dairy products is available under the brand name of CRYOVAC® from Sealed Air

Corporation of Elmwood Park, N.J., USA

In the case of fresh produce, modified atmosphere packaging provides a decreased level of oxygen and an elevated level of carbon dioxide within a package of fresh produce, which thereby preserves quality of the produce.

In accordance with a preferred embodiment of the present invention, the sensor modules, such as sensor module 100, sense one, and preferably more than one, of the following parameters which indicate the status of the perishables: temperature, light, vibration, relative humidity and the concentration of one or more of O₂, CO₂, ethanol, microbial volatiles indicating the presence of pathogens or spoilage microorganisms. Sensor module 100 may also sense the concentration of ethylene, it being appreciated that this may be of limited importance when modified atmosphere packaging is employed, since modified atmosphere packaging for fresh produce typically inhibits the biosynthesis and action of ethylene. The sensor module 100 also preferably provides a time stamp.

In accordance with a preferred embodiment of the present invention there is also provided a Perishable Lifecycle Manager (PLM) 104, preferably including, inter alia, remaining lifetime prediction functionality, supply chain link accountability functionality and first expired, first out (FEFO) logistics functionality. The PLM 104 communicates with at least one sensed inputs integrator and communicator (SIIC) 102 and is operative, inter alia, to calculate a predicted remaining lifetime of the perishable and to manage its logistics based on the information relating to the parameters. The PLM 104 is preferably embodied in at least one server which is remotely located from sensor modules 100 and sensed inputs integrator and communicators (SIICs) 102 and preferably communicates with them via a computer network, such as the internet, and via one or more wireless network 107, such as GPRS, or via a LAN 108, using one or more communication servers 106. Communication server 106 preferably includes communication management functionality, operative to manage communication between SIICs 102 and PLM 104, as well as monitoring functionality, operative to monitor SIICs 102 to ensure that SIICs are operational and transmitting data, and remote diagnostic and maintenance functionality, operative to provide remote diagnostics and maintenance of SIICs 102.

In accordance with a preferred embodiment of the present invention there is provided at least one, and preferably multiple, user interfaces 110 providing to users information relating, inter alia to remaining lifetime prediction, supply chain link accountability and first expired, first out logistics of perishables whose parameters are sensed by sensor modules 100.

Typical users include customers, growers, shippers, transporters and insurers as well as health departments and other agencies.

The user interfaces 110 preferably employ client software resident on a client computer as shown. Alternatively, the user interfaces or part thereof may also reside on the same server which functions as PLM 104. As a further alternative some or all of the software of PLM 104 may reside on one or more client computers.

It is appreciated that a PLM 104 may serve various clients and various organizations and may communicate with the user interfaces 110 via a suitable computer network, such as the internet. It is appreciated that different users typically will have access to different information, according to their need to know or their role in cold chain management. Alternatively, client and/or organization specific PLMs 104 may be provided and may communicate via dedicated communication servers 112 with one or more SIICs 102.

It is appreciated that preferably communication between the various elements of the system takes place over a computer network, such as the internet.

In the illustrated embodiment of FIGS. 1A-1H, the sensor module 100 typically includes a housing 118 including mutually displaceable portions 120 and 122 and a safety catch 124, which, when in place, prevents mutual displacement of portions 120 and 122. An antenna 126 preferably extends outwardly from housing 118. Antenna 126 is preferably flexible so as to allow housing 118 to be located at the interior of a pallet of packaged perishables and for at least an outer end of antenna 126 to extend outside of the pallet. Preferably, a visually sensible sensor module identifier, such as a barcoded label 130, is provided at the end of antenna 126 to enable ease of association of a given sensor module 100 with a given pallet 128 (FIG. 1B), which is also identified by a pallet identifier, preferably a barcoded label 132 (FIG. 1B). It is appreciated that reference to a pallet throughout is intended to include any other package or collection of packages and may include one or more cartons, bins or other containers which are typically kept together during storage and/or shipment. The term Monitorable Shipping Unit (MSU) is used to refer to one or more packages which are monitored by a given sensor module 100.

Optionally, an external sensor probe 134 may be connected to sensor module 100 so as to enable the probe to be inserted into a perishable or into a package thereof, while the sensor-module 100 remains outside.

In accordance with a preferred embodiment of the present invention, a sensor module 100 or an external probe 134 may be located within modified atmosphere packaging which is operative to maintain predetermined optimal gas concentrations therein for a given perishable, provided that the temperature and possibly other parameters are maintained within a predetermined range,

It is a particular feature of the present invention that near real time monitoring of at least temperature within or in the vicinity of a modified atmosphere package 136 (FIG. 1B), containing a perishable, synergistically enhances the shelf-life enhancing functionality of the modified atmosphere package 136 and concomitantly helps to prevent catastrophic consequences which may result from maintaining perishables in modified atmosphere packaging under unacceptable temperature or other conditions.

It is appreciated that a sensor module 100 and/or probe 134 may be associated with any suitable type of MSU. Depending on the value of the perishable, a sensor module 100 and/or probe 134 may be associated with each package, preferably a modified atmosphere package 136.

Within a given MSU which includes more than one package, one or more probe may be located within a randomly or purposefully selected sample of plural packages, such as packages grouped as a pallet. Notwithstanding that in the description of the present invention reference is usually made to a sensor module 100 and/or probe 134 being associated with only one package in a pallet, the present invention is not so limited.

Actuation of operation of a sensor module 100 takes place typically as shown in FIG. 1A, by a user removing safety catch 124 and pushing portions 120 and 122 axially towards each other, as indicated by arrow 138. Actuation is typically confirmed by illumination of a visible indicator such as a LED 140. An actuation time stamp is preferably communicated to a sensed inputs integrator and communicator (SIIC) 102 by any suitable communication pathway, which is preferably wireless. Successful communication between the sensor module 100 and a sensed inputs integrator and communicator (SIIC) 102 may be indicated by a predetermined pattern of illumination of LED 140.

Turning now to FIG. 1B, it is seen that one sensor module, here shown without a probe and designated by reference numeral 142, is placed within modified atmosphere package 136 with antenna 126 and label 130 extending outside of the package. One or more such modified atmosphere package, each having a sensor module associated therewith, are typically placed in one or more carton 144 and stacked in pallet 128. Preferably, carton 144 is located at the interior of the pallet 128 and another carton, here designated by reference numeral 146 and including a modified atmosphere package and a sensor module 148, is located at the outside of the pallet 128, as shown. In this case, it is seen that there are two MSUs in a single pallet. It is appreciated that preferably, once actuated, the sensor modules 100 report on various parameters of the perishables via one or more sensed inputs integrator and communicators (SIICs) 102 to PLM 104 via one or more communication servers 106 and one or more wireless networks 107, such as GPRS, or via a LAN 108, and a computer network, such as the internet.

FIG. 1C shows association of one or more sensor modules 100 with a given pallet 128, typically by using a barcode reader 150 to read and correlate barcode label 130 of the sensor module 100 and barcode label 132 of the pallet 128. A preferred barcode reader is a Portable Data Collection Terminal Input Model M3, commercially available from Mobilecompia Co. Ltd. of Korea. Preferably, the barcode reader 150 outputs the correlation information via any suitable computer network link, directly to PLM 104. Preferably, the barcode label 132 includes information as to the type of perishable, harvest date, packing date, origin and currently contemplated destination as well as any other information required to provide accurate remaining lifetime predictions and action recommendations.

Alternatively or additionally, duplicate barcode labels 130 and 132, such as removable adhesive-backed labels, may be provided so that reading of the barcode labels 130 and 132 for correlating one or more given sensor module 100 with the pallet 128 in which they is located, may be carried out at a location remote from the pallets.

FIG. 1C also shows the operation of the system during forced air cooling prior to storage and shipment. One or more sensor modules 100 on each of pallets 128 provide a real-time remote indication of temperature of the perishables. The temperature indication may be provided for precise locations within each pallet by suitable placement of probes 134. An SIIC 152 is preferably provided within a cooling chamber 154 and provides near real time output indication of sensed temperature of the perishables. The SIIC 152 preferably output to a cooling controller 156 which automatically terminates the cooling operation when desired end point temperatures have been reached and/or provides an operator sensible indication at this stage. SIIC 152 also preferably communicates with PLM 104 via one or more communication servers 106 and one or more wireless networks 107, such as GPRS, or via a LAN 108, and a computer network, such as the internet.

It is appreciated that FIGS. 1B and 1C show an example wherein multiple MSUs are located in a single pallet. In such a case, association of the sensor module 100 with the pallet does not necessarily indicate the precise location of each of the MSUs in the pallet and thus does not indicate, for example, which of the MSUs is at the interior of the pallet and which is at the exterior. This ambiguity may be resolved by entry of suitable additional information by the person carrying out the association to indicate the locations of each of multiple MSUs in a pallet.

FIG. 1D shows typical storage and pre-shipping operations at any suitable stage in a supply chain at a warehouse containing multiple pallets 128, each associated with at least one sensor module 100. The sensor modules 100 each communicate with at least one sensed inputs integrator and communicator (SIIC) 102, which in turn communicates with PLM 104 via one or more communication servers 106 and one or more wired or wireless network 107, such as GPRS, or via a LAN 108, and a computer network, such as the internet. PLM 104 preferably communicates with at least one and preferably multiple user interfaces 110 providing to users information relating, inter alia to remaining lifetime prediction, supply chain link accountability and first expired, first out logistics of perishables whose parameters are sensed by sensor modules 100.

In the present example illustrated in FIG. 1D, it is seen that one or more pallets 128 are left in the sun causing a temperature rise. This temperature rise is reported by the sensor modules 100 associated with the pallets via SIIC 102 and optionally via PLM 104 and user interfaces 110, resulting in a temperature exceedance warning being provided to an interested party, such as a shipper, transporter, customer, insurer or health department. Here, communication from the SIIC 102 may be direct to the user interfaces 110, as via a direct internet connection via a dedicated communication server 112. This direct connection may bypass communication server 106 and PLM 104.

Such interested party may provide a suitable handling instruction for dealing with a pallet for which a temperature exceedance warning is outstanding. Such instructions may include, for example, instructions to re-cool the pallet, manually inspect the pallet, reject the pallet or redirect the pallet to another destination. Additionally or alternatively, the quality grade of the perishable on the pallet may be downgraded.

It is appreciated that the communication to and from interested parties may be communicated by any suitable communications pathway, including but not limited to email, SMS and voice message. The instructions are preferably communicated via a computerized data network, but may be communicated over a voice network.

FIG. 1D also shows an example where pallets stored in a given location of a warehouse become overheated, perhaps due to an air conditioning failure or improper air circulation in the warehouse. Here also, the temperature rise is reported by the sensor modules 100 associated with the pallets via SIIC 102 which may be connected to one or more wired or wireless network 107, such as GPRS, or via LAN 108 to server 106 and may communicate via PLM 104 and user interfaces 110, resulting in an temperature exceedance warning being provided.

Reference is now made to FIG. 1E, which illustrates typical land transport operations at any suitable stage in a supply chain. The status of the perishables is communicated by one or more sensor modules 100 associated with each pallet via a truck-mounted sensed inputs integrator and communicator (SIIC) 102, which in turn communicates with PLM 104 via one or more wired or wireless network 107, preferably a cellular network such as GPRS, and one or more communication servers 106. The SIIC 102 may additionally communicate its location, which is preferably ascertained using an integrated conventional GPS locator 160, via the same communications link. It is appreciated that the SIIC 102 may be fixedly mounted within a truck or cargo container or may be removably mounted therein. A possible advantage of using a removably mounted SIIC 102 is that it enables the SIIC to be associated with one or more MSUs throughout the cold chain and not just at a given transport or storage stage therein.

Alternatively, the truck may not be equipped with an SIIC. In this alternative, sensor module 100 may perform the logging function and upon re-establishment of communication, such as upon arrival at a destination, communicate the logged information to the remainder of the system via an SIIC located at the destination.

PLM 104 preferably communicates with at least one and preferably multiple user interfaces 110 providing to users information relating, inter alia, to remaining lifetime prediction, supply chain link accountability and first expired, first out logistics of perishables whose parameters are sensed by sensor modules 100.

In the present example illustrated in FIG. 1E, parameters relating to the perishables are reported by the sensor modules 100 associated with the pallets 128 via a truck-mounted SIIC 102 and/or a portable SIIC 161, which may be attached to one of the pallets 128 in a shipment, and optionally via PLM 104 and user interfaces 110, resulting in suitable notifications being provided to an interested party, such as a shipper, transporter, customer, insurer or health department. In some cases, communication from the SIIC 102 may be direct to the user interfaces 110, as via a direct internet connection via a dedicated communication server 112. This direct connection may bypass communication server 106 and PLM 104. It is appreciated that communications to and from the interested party need not necessarily be via a computer but rather the user interfaces 110 may include various types of messaging functionality, such as SMS, voicemail and email.

Such interested party may, as appropriate, provide a suitable handling instruction for dealing with a pallet for which a perishable lifetime reduction warning is outstanding. Such instructions may include, for example, instructions to the truck driver to redirect the pallet to another destination or to actuate or repair the truck refrigeration unit. Additionally or alternatively, the quality grade of the perishable on the pallet may be downgraded.

Additionally, as illustrated in FIG. 1E, at a border crossing, the truck may be opened for inspection, causing a light sensor in one or more sensor module 100 to indicate that the cargo compartment of the truck was opened. Opening of the cargo compartment of the truck may also cause a temperature rise which is sensed by a sensor module 100.

Reference is now made to FIG. 1F, which illustrates typical sea transport operations at any suitable stage in a supply chain. The location of the perishables initially may be communicated by sensor modules 100 associated with each pallet 128 via a truck-mounted sensed inputs integrator and communicator (SIIC) 102, which location is preferably ascertained using an integrated conventional GPS locator 160.

SIIC 102 in turn communicates with PLM 104, typically via a cellular network and one or more communication servers 106 and one or more wired or wireless networks 107, such as GPRS, and the internet.

Alternatively, the truck may not be equipped with an SIIC. In this alternative, sensor module 100 may perform the logging function and upon re-establishment of communication, such as upon arrival at a destination, communicate the logged information to the remainder of the system via an SIIC located at the destination.

Upon unloading of the pallets at the port, the sensor modules 100 communicate information relating to various parameters relevant to the status of the perishables with a fixed location SIIC 170 at the port. SIIC 170 preferably communicates via a LAN 172 and preferably via a computer network such as the Internet, with PLM 104 and possible also with one or both of servers 106 and 112. In the illustrated example of FIG. 1F, if pilfering occurs, a change in the gas composition of a package, preferably a modified atmosphere package, is sensed by a relative humidity sensor and/or a gas composition sensor in a sensor module 100 associated with the package. The information sensed by the sensor module 100 may be communicated via the fixed location SIIC 170 at the port to PLM 104, which preferably communicates with at least one, and preferably multiple user interfaces 110, providing to users an indication of tampering with the perishable whose parameters are sensed.

Alternatively or additionally, containers with or without SIICs containing pallets 128 having sensor modules 100 associated therewith may arrive at the port. The sensor modules 100 may communicate sensed information regarding the status of the perishables contained therein via the fixed location SEC 170 at the port.

Once the pallets 128, having associated therewith sensor modules 100, have been loaded onto a ship, whether or not the pallets are in cargo containers, the sensor modules 100 may communicate with one or more ship-borne SIICs 180 and one or more container-borne SIICs 181 and may thus communicate parameters relating to the perishables via the ship-borne SIICs 180 and/or the container-borne SIICs 181, which in turn may be connected to a ship-borne internet gateway 182 by one or more LAN 184 and to on-board refrigeration and security control systems. Information regarding perishables may be communicated via ship-borne SIICs 180 and/or the container-borne SIICs 181, ship-borne internet gateway 182 and a communications satellite 186 via a computer network such as the internet to PLM 104, which preferably communicates with at least one and preferably multiple user interfaces 110 providing to users an indication of events which could affect the quality of perishables whose parameters are sensed.

Alternatively, if there is no communication between the sensor modules 100 and the remainder of the system during transport, the sensor modules 100 preferably log all relevant parameters with appropriate time stamps and upon re-establishment of communication, such as upon arrival at a destination, communicate the logged information to the remainder of the system.

As a further alternative, if there is communication between the sensor modules 100 and an SIIC but no communication between the SIIC and the remainder of the system, the SIIC may perform the logging function and upon re-establishment of communication, such as upon arrival at a destination, communicate the logged information to the remainder of the system.

Events related to the perishables are reported by the sensor modules 100 associated with the pallets via one or more of SIICs 102, 170, 180 and 181 and optionally via PLM 104 and user interfaces 110, resulting in suitable notifications being provided to one or more interested party, such as a shipper, transporter customer, insurer or health department. Communication from an SIIC may be direct to the user interfaces 110, as through a direct internet connection via a dedicated communication server 112. This direct connection may bypass communication server 106 and PLM 104.

Such interested party may, as appropriate, provide a suitable handling instruction for dealing with a pallet for which a temperature exceedance warning is outstanding. Such instructions may include, for example, instructions to ship personnel to repair or reset refrigeration equipment. Additionally or alternatively, the quality grade of the perishable on the pallet may be downgraded.

It is appreciated that the communication to and from interested parties may be communicated by any suitable communications pathway, including but not limited to email, SMS, voice message. The instructions are preferably communicated via a computerized data network, but may be communicated over a voice network.

Reference is now made to FIG. 1G, which illustrates typical air transport operations at any suitable stage in a supply chain.

At an originating airport, sensor modules 100 communicate information relating to various parameters relevant to the status of perishables in pallets 128 via a fixed location SIIC 190 at the originating airport, which may be connected via a LAN 191 or via one or more wired or wireless network 107, preferably a cellular network such as GPRS, to the remainder of the system.

Once the pallets 128, having associated therewith sensor modules 100, have been loaded onto an aircraft, if no aircraft-borne SIIC is provided, the sensor modules do not provide communication. If an aircraft-borne SIIC 192 is provided, the sensor modules 100 may communicate parameters relating to the perishables via the aircraft-borne SIIC 192, which in turn may be connected to an aircraft-borne internet gateway 194 as by a LAN 196.

Alternatively, if there is no communication between the sensor modules 100 and the remainder of the system during transport, the sensor modules 100 preferably log all relevant parameters with appropriate time stamps and upon re-establishment of communication, such as upon arrival at a destination airport, communicate the logged information to the remainder of the system.

As a further alternative, if there is communication between the sensor modules 100 and SIIC 192 but no communication between the SIIC 192 and/or the internet gateway 194 and the remainder of the system, the SIIC 192 may perform the logging function and upon re-establishment of communication, such as upon arrival at a destination, communicate the logged information to the remainder of the system.

At a destination airport having a fixed location SIIC 198, events related to the perishables are reported by the sensor modules 100 associated with the pallets 128 via SIIC 198, which may be connected via a LAN 199 or via one or more wired or wireless network 107, preferably a cellular network such as GPRS, to the remainder of the system. This information maybe provided to PLM 104 and/or directly to user interfaces 110, resulting in suitable notifications being provided to an interested party, such as a shipper, transporter, customer, insurer or health department. Such interested party may, as appropriate, provide a suitable handling instruction for dealing with a pallet for which a temperature exceedance warning is outstanding. Such instructions may include, for example, instructions to re-cool the pallets. Additionally or alternatively, the quality grade of the perishable on the pallet may be downgraded.

It is appreciated that the communication to and from interested parties may be communicated by any suitable communications pathway, including but not limited to email, SMS, voice message. The instructions are preferably communicated via a computerized data network, but may be communicated over a voice network.

In the illustrated example, the presence of a pathogen in the perishables may be indicated by an output of a gas sensor or electronic nose that detects volatiles released by pathogenic microorganisms forming part of a sensor module 100 communicating with the system via SIIC 192 or SIIC 198. This indication, which may or may not be coupled with a temperature exceedance warning based on temperatures during air shipment may be provided to appropriate personnel, such as health department personnel who may initiate quarantine.

Reference is now made to FIG. 1H, which illustrates the end of a supply chain, wherein the perishables arrive at a customer's facility. At this stage a “sell by” date output may be received, preferably at a suitable computer terminal 200 from PLM 104, preferably via an internet connection. The “sell by” date output is preferably pallet specific and indicates the status of each pallet of perishables. As illustrated in FIG. 1H, the indicated status may be, for example, one of the following:

SELL BY JAN. 1, 2009

SELL BY JAN. 2, 2009

SELL BY JAN. 3, 2009

DO NOT SELL

REDUCE PRICE FOR IMMEDIATE SALE

SPECIAL HANDLING

Preferably, but not necessarily, the customer facility includes a customer facility SIIC 202, to enable continued monitoring of the perishables. SIIC 202 may communicate with the remainder of the system via a computer network, such as the internet, and via one or more wireless network 107, such as GPRS, or via a LAN 204 for providing an updated “sell by” date output.

Additionally, in accordance with a preferred embodiment of the invention, PLM 104 may be operative to provide an advance notification of impending arrival of distressed perishables. The customer or his insurance company may respond to the advance notification of impending arrival of distressed perishables by arranging for an insurance assessor to be present upon arrival of the shipment at the customer facility. Preferably, the monitored history of the shipment is made available to the assessor in advance of or concurrently with arrival of the shipment.

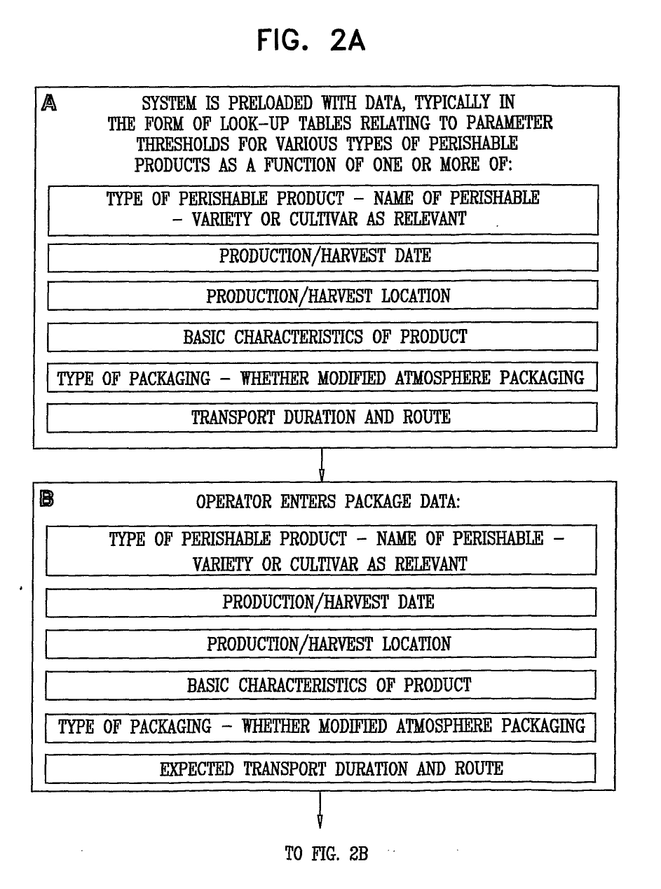

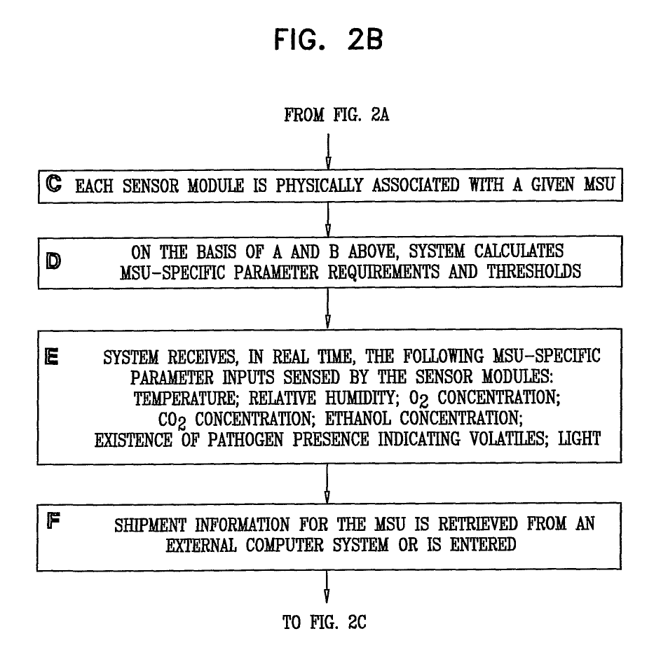

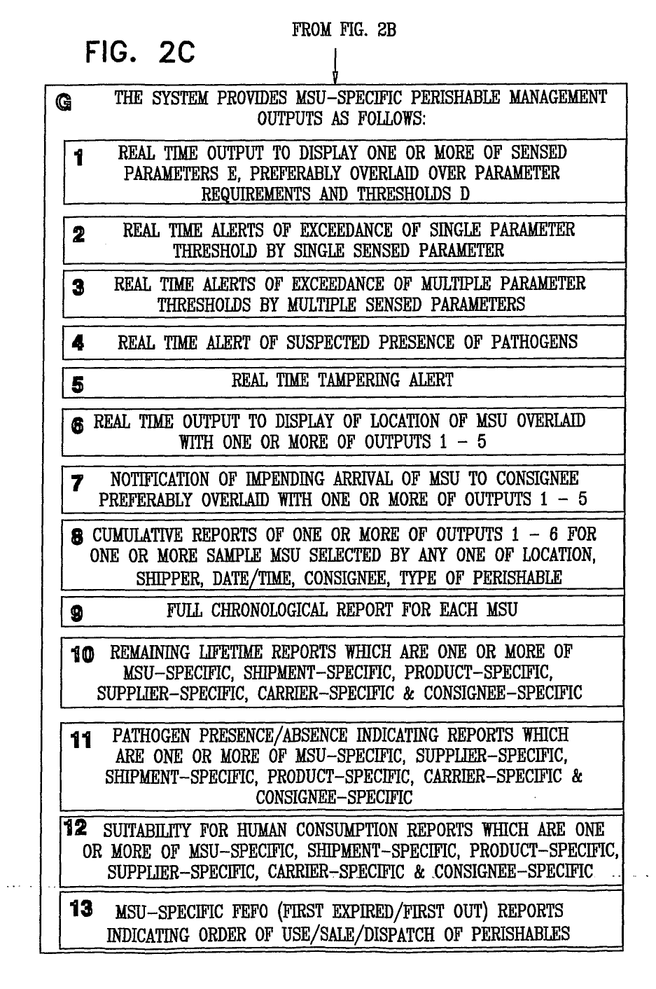

Reference is now made to FIGS. 2A-2C, which, taken together, form a simplified functional block diagram of the system of FIGS. 1A-1H.

As seen in FIGS. 2A-2C, the system is preloaded with relevant data, typically is the form of a plurality of look-up tables relating to parameter thresholds for various types of perishable products. The parameter thresholds are preferably a function of one or more of the following data items, relating to the perishable product: a product type, which may include a variety or cultivar; a product production and/or product harvest date; a product production and/or product harvest location; one or more basic characteristics of the product; packaging type, such as is the product in a modified atmosphere package, and product transportation duration and route.

For each package being entered into the system for tracking, an operator preferably enters the relevant information for the package, including a product type, which may include a variety or cultivar; a product production and/or product harvest date; a product production and/or product harvest location; one or more basic characteristics of the product; packaging type, such as is the product in a modified atmosphere package, and product transportation duration and route.

The operator also preferably physically associates a sensor module with a given monitorable shipping unit (MSU). Alternatively, any other package handler may physically associate a sensor module with a given monitorable shipping unit (MSU).

The operator or other package handler typically physically associates a given MSU with a sensor module by using a barcode reader to read and correlate a barcode label of the sensor module and a barcode label of the pallet, as described hereinabove with reference to FIG. 1C.

Based on the specific information provided for the package being entered into the system, the system is then preferably operative to calculate MSU-specific parameter requirements and thresholds for the current package.

Once the package has been entered into the system and the sensor module or sensor modules are activated, the sensor modules are preferably operative to provide, as inputs to the system, the following MSU-specific information, preferably in near real time, as sensed by the sensor modules: temperature, relative humidity, concentration of O₂, concentration of CO₂, concentration of ethanol, existence of pathogen presence indicating volatiles and light level.

The system also preferably retrieves shipment information relating to the MSU from an external computer system. Alternatively, the shipment information is entered into the system. Examples of shipment information include identification data regarding the transport vehicle and its driver and the transportation company, the set point temperature of the transport vehicle, the ventilation settings of the transport vehicle, the intended destination and route, driver contact information, the intended destination and route, identification and contact data regarding the consignee, the insurer and any relevant regulatory agency identification and contact data.

The system of the present invention is preferably operative to provide the following perishable management outputs:

1. A near real-time output displaying one or more parameters measured by the sensor module or sensor modules, such as temperature, relative humidity, concentration of O₂, concentration of CO₂, concentration of ethanol, existence of pathogen presence indicating volatiles and light level. Additionally, the system also preferably includes the parameter requirements for each of the parameters measured, such as optimal range, minimum threshold and maximum threshold. In a preferred embodiment of the present invention the parameters sensed are displayed together with the corresponding range and thresholds for the parameter for the specific MSU;

2. A near real time alert of exceedance of a single parameter threshold by a single sensed parameter;

3. A near real time alert of exceedance of multiple parameter thresholds by multiple sensed parameters;

4. A near real time alert of suspected presence of pathogens;

5. A near real time tampering alert;

6. A near real time output showing the location of the MSU overlaid with an indication of any of outputs 1-5;

7. A notification of impending arrival of MSU to consignee, preferably overlaid with one or more of the above listed outputs 1-5;

8. Cumulative reports of one or more of outputs 1-6 for one or more sample MSUs selected by any one of location, shipper, date/time, consignee, type of perishable;

9. A full chronological report for each MSU;

10. Remaining lifetime reports which are one or more of MSU-specific, shipment-specific, product-specific, supplier-specific, carrier-specific & consignee-specific;

11. Pathogen presence/absence indicating reports which are one or more of MSU-specific, supplier-specific, shipment-specific, product-specific, carrier-specific and consignee-specific;

12. Suitability for human consumption reports which are one or more of MSU-specific, shipment-specific, product-specific, supplier-specific, carrier-specific and consignee-specific; and

13. MSU-specific FEFO (first expired/first out) reports indicating order of use/sale/dispatch of perishables.

The terms “near real time alert” and “near real time output” refer to an alert and an output, respectively, which, although not immediate, are sufficiently close in time to an event to enable remedial or corrective action to be taken.

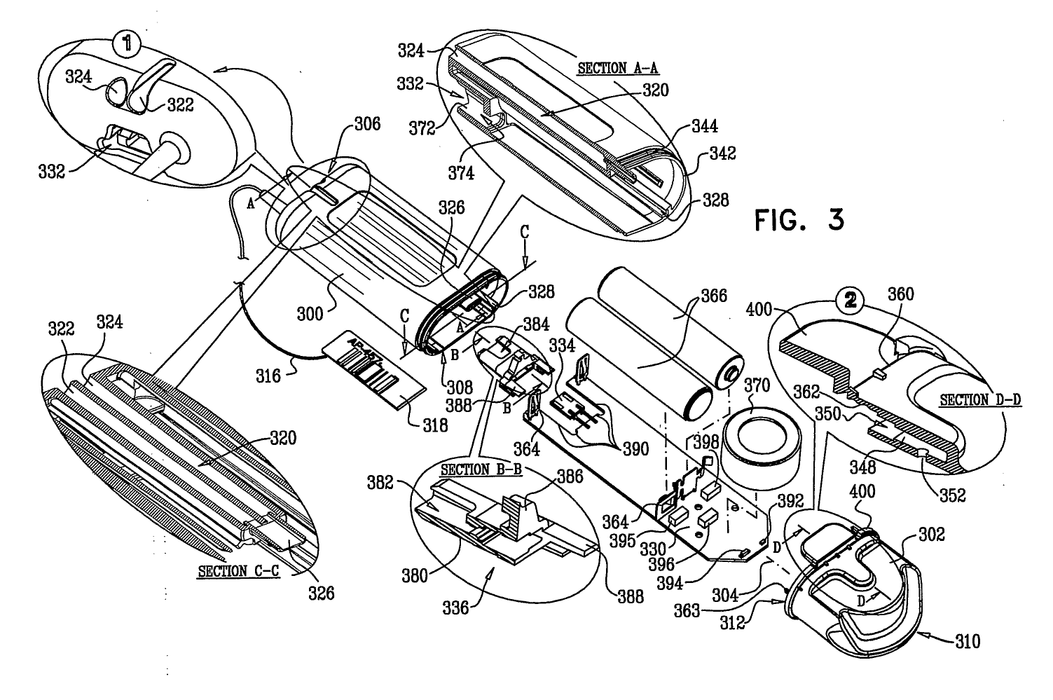

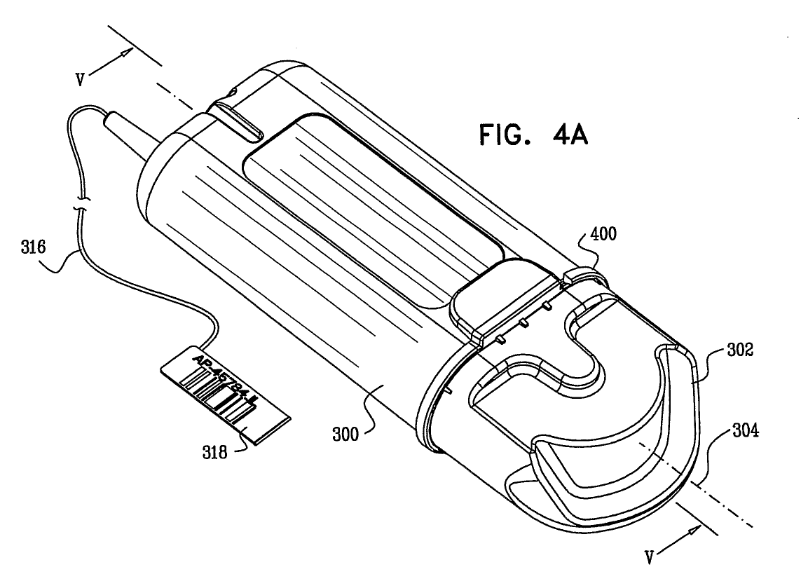

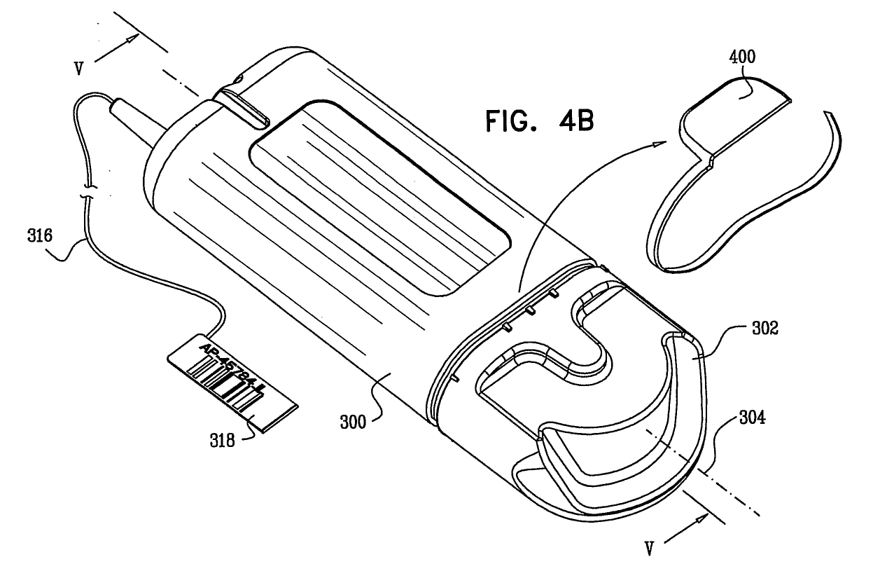

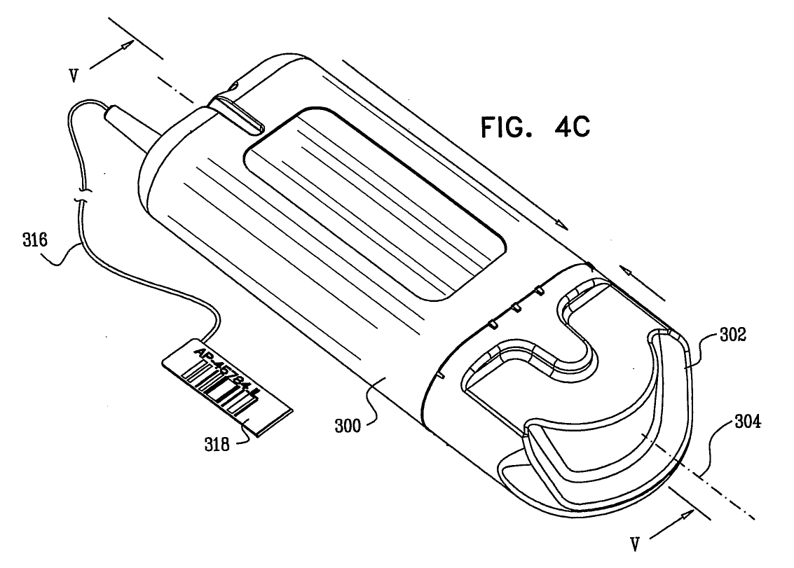

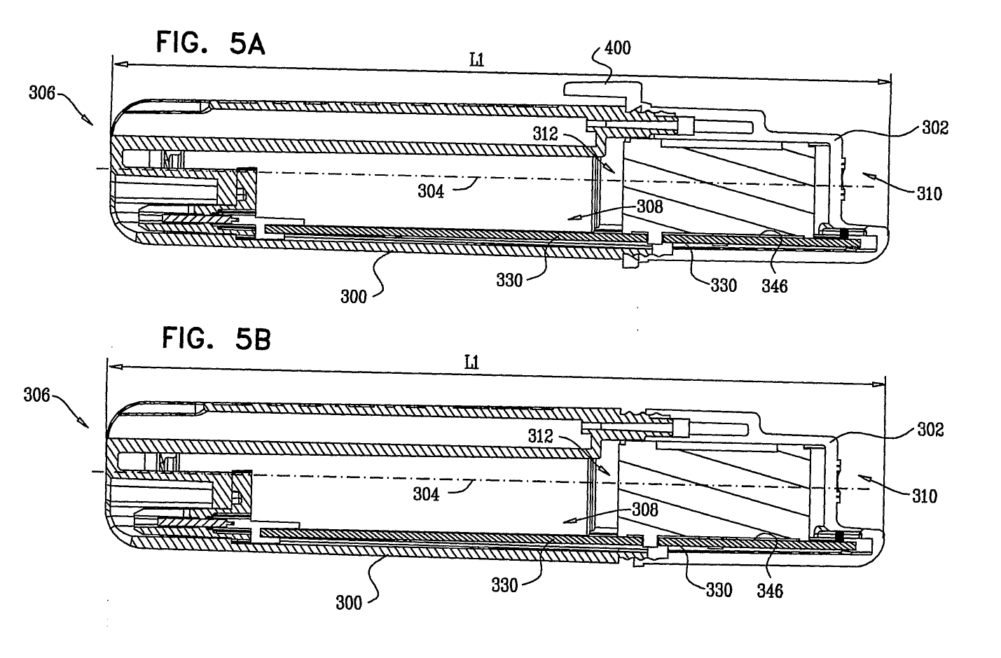

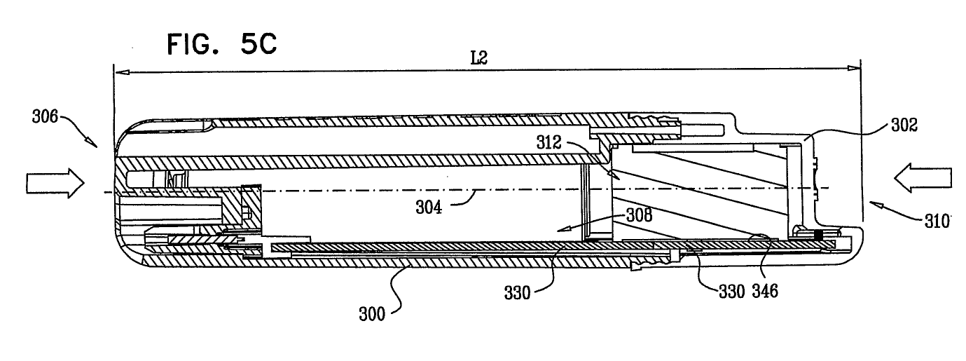

Reference is now made to FIG. 3, which is a simplified exploded view illustration of an embodiment of a sensing module employed in the system of FIGS. 1A-1H and 2A-2C; to FIGS. 4A, 4B and 4C, which are simplified pictorial illustrations of the sensing module of FIG. 3 and to FIGS. 5A, 5B and 5C, which are simplified sectional illustrations taken along lines V-V in corresponding FIGS. 4A-4C.

As seen in FIGS. 3-5C, the sensing module preferably comprises a generally cylindrical main housing portion 300 and a cap portion 302 which is selectably positionable with respect to main housing portion 300 along a displacement axis 304. Main housing assembly 300 preferably includes a closed end 306 and an open end 308. Cap portion 302 preferably includes a closed end 310 and an open end 312.

A flexible elongate antenna 316 extends from closed end 306 of main housing portion 300. A machine-readable identification tag 318, preferably bearing a barcode, is preferably attached to an outer end of antenna 316. Antenna 316 is typically at least one meter in length.

Main housing portion 300 preferably includes a preferably bifurcated ambient air passage channel 320 which, as seen particularly in enlargement 1, has an elongate inlet 322 and an outlet 324 at closed end 306 of main housing assembly 300 and communicates with a coupling outlet 326 which protrudes from open end 308 of main housing portion 300.

Main housing portion 300 comprises an interior slot 328 for receiving and retaining a printed circuit board 330. At closed end 306, main housing assembly includes an ambient air communication opening 332 in which is positioned a relative humidity sensor 334 mounted on a sensor support element 336, both of which are described hereinbelow.

Adjacent open end 308 of main housing portion 300, at a peripheral edge 342 thereof, there is provided an external peripheral bifurcated groove 344.

Cap portion 302 comprises an interior slot 346 (FIGS. 5A-5C) for receiving printed circuit board 330 and, as seen particularly in enlargement 2, also comprises an ambient air passage channel 348 having an inlet 350, which communicates with coupling outlet 326, and an outlet 352. Adjacent open end 312 of cap portion 302, at a peripheral edge 360 thereof, there is provided an internal peripheral bifurcated protrusion 362 and a pair of axial protrusions 363.

Printed circuit board 330 is disposed in slot 328 mainly within cylindrical main housing portion 300. Battery contact supports 364 are mounted on printed circuit board 330 and support batteries 366. An optional oxygen sensor 370, such as a model O2-G1 commercially available from Alphasense, Great Notley, UK, is also preferably mounted on printed circuit board 330 adjacent to outlet 352 of ambient air passage channel 348.

Relative humidity sensor 334, such as a model H5M3, commercially available from Sensera Company Ltd. of 9F-5, No. 26, Sec. 3, Jen-Ai Road, Taipei, Taiwan 106, ROC, is electrically coupled to printed circuit board 330 and extends outwardly thereof along axis 304.

As noted above, relative humidity sensor 334 is mounted on sensor support element 336 in ambient air communication opening 332. Ambient air communication opening 332 includes a generally planar passageway 372 and a recess 374 located thereabove. Sensor support element 336 preferably comprises a generally planar portion 380 which includes an interior slot 382 which receives relative humidity sensor 334. Slot 382 has a top opening 384 which allows relative humidity sensor 334 to be exposed to ambient air in recess 374 of ambient air communication opening 332. It is particularly noted that relative humidity sensor 334 fits snugly within slot 382, so as to prevent ambient air from entering the interior of the sensor module via slot 382. Similarly, planar portion 380 fits snugly into correspondingly-sized passageway 372 of ambient air communication opening 332, so as to prevent ambient air from entering the interior of the sensor module via passageway 372.

Sensor support element 336 also includes an upstanding portion 386 which acts as a stop when sensor support element 336 is inserted in main housing portion 300 into engagement with ambient air communication opening 332. A pair of mounting slots 388 are formed on sensor support element 336 to enable sensor support element to engage corresponding edges 390, alongside relative humidity sensor 334 and spaced therefrom, of printed circuit board 330. This engagement preferably provides mutual support between the printed circuit board 330 the sensor support element 336 and the main housing portion 300 in which the sensor support element 336 is snugly mounted.

A temperature sensor 392, preferably a THERMISTOR NCP 18XW222J03RB, commercially available from Murata Manufacturing Co. Ltd. of Japan, and a LED 394, which provides a visible indication of sensor operation, are also preferably mounted on printed circuit board 330.

A CPU 395 and an associated memory 396 receive inputs from the various sensors and communicate wirelessly with SRC 102 via a transceiver 398. Additional circuit components (not shown) are also mounted on printed circuit board 330.

A selectably removable, single use, peripheral seal 400 is preferably integrally formed with and removably attached to edge 360 of open end 312 of cap portion 302, when the sensing module is in a pre-actuation operative orientation, as shown in FIGS. 4A and 5A. In this pre-actuation operative orientation, seal 400 is disposed in bifurcated groove 344, thus retaining cap 302 in a first position relative to the main housing portion 300 along displacement axis 304, as seen in FIGS. 4A, 4B, 5A and 5B.

When intact and in place, seal 400 does not allow the cap 302 to be brought into greater propinquity with the main housing assembly 300 along displacement axis 304 and the length of the sensing module is L1, as seen in FIGS. 5A and 5B. When seal 400 is removed, cap 302 may be slid towards main housing assembly 300 along displacement axis 304 to a second position, and the length of the sensing module is L2, as seen in FIGS. 4C and 5C, which is less than length L1 of FIGS. 5A and 5B. Once cap 302 is in the second position relative to the housing assembly 300, as seen in FIGS. 4C & 5C, it is retained in that position by the engagement of peripheral protrusions 362 on cap 302 and corresponding grooves 344 on main housing portion 300.

Mutual displacement of the main housing portion 300 and the cap portion 302 towards each other to the mutual orientation shown in FIGS. 4C & 5C produces actuation of the sensor module, which is preferably indicated by a predetermined illumination pattern of LED 394. Actuation is preferably achieved by engagement of axial protrusions 363 with adjacent respective ones of battery contact supports 364.

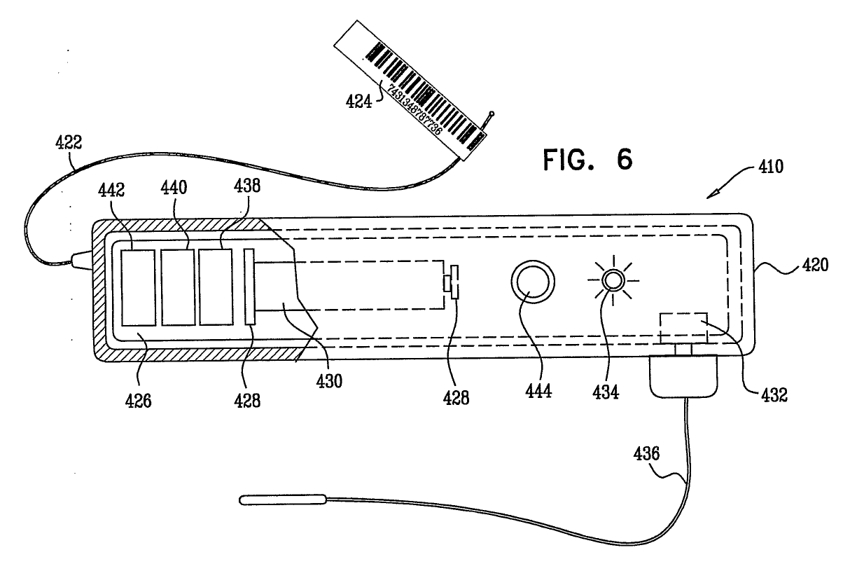

Reference is now made to FIG. 6, which is a simplified exploded view illustration of an embodiment of another sensing module useful in the system of FIGS. 1A-1H and 2A-2C.

As seen in FIG. 6, a sensing module 410 preferably comprises a housing 420. A flexible elongate antenna 422 extends from housing 420. A machine-readable identification tag 424, preferably bearing a barcode, is preferably attached to an outer end of antenna 422. Antenna 422 is typically at least one meter in length.

Housing 420 preferably includes a printed circuit board 426 on which are mounted battery contact supports 428, which support a battery 430.

A temperature sensor 432, preferably a THERMISTOR NCP 18XW222J03RB, commercially available from Murata Manufacturing Co. Ltd. of Japan, and a LED 434, which provides a visible indication of sensor operation, are also preferably mounted on printed circuit board 426. An external temperature sensor assembly 436, preferably in the form of a probe, may be employed.

A CPU 438 and an associated memory 440 receive inputs from the temperature sensor 432 and/or from external temperature sensor assembly 436 and communicate wirelessly with SIIC 102 (FIGS. 1A-1H) via a transceiver 442. Additional circuit components (not shown) are also mounted on printed circuit board 426.

A selectably actuable actuation switch 444 is preferably mounted on housing 420. Actuation of switch 444 produces actuation of the sensor module, which is preferably indicated by a predetermined illumination pattern of LED 434.

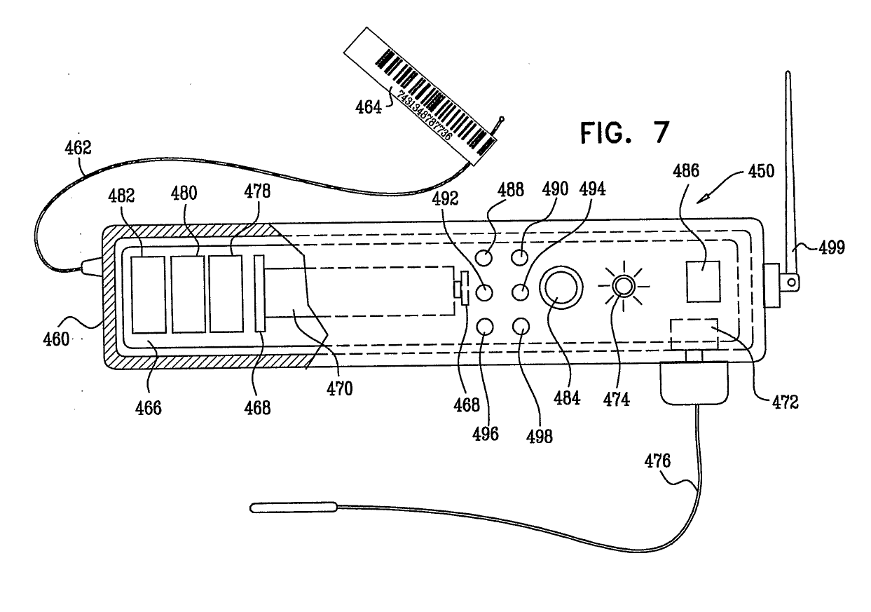

Reference is now made to FIG. 7, which is a simplified exploded view illustration of an embodiment of yet another sensing module useful in the system of FIGS. 1A-1H and 2A-2C.

As seen in FIG. 7, a sensing module 450 preferably comprises a housing 460. A flexible elongate antenna 462 extends from housing 460. A machine-readable identification tag 464, preferably bearing a barcode, is preferably attached to an outer end of antenna 462. Antenna 462 is typically at least one meter in length.

Housing 460 preferably includes a printed circuit board 466 on which are mounted battery contact supports 468, which support a battery 470.

A temperature sensor 472, preferably a THERMISTOR NCP 18XW222J03RB, commercially available from Murata Manufacturing Co. Ltd. of Japan, and a LED 474, which provides a visible indication of sensor operation, are also preferably mounted on printed circuit board 466. An external temperature sensor assembly 476, preferably in the form of a probe, may be employed.

A CPU 478 and an associated memory 480 receive inputs from the temperature sensor 472 and/or from external temperature sensor assembly 476 and communicate wirelessly with SIIC 102 (FIGS. 1A-1H) via a transceiver 482. Additional circuit components (not shown) are also mounted on printed circuit board 466.

A selectably actuable actuation switch 484 is preferably mounted on housing 460. Actuation of switch 484 produces actuation of the sensor module, which is preferably indicated by a predetermined illumination pattern of LED 474.

Also mounted on printed circuit board 466 are one or more additional sensors, such as a relative humidity sensor 486, an O₂ sensor 488, a CO₂ sensor 490, a C₂H₄ sensor 492, a C₂H₅OH sensor 494, a pathogen sensor 496 and a light sensor 498. A GPS antenna 499, which enables the precise location of the MSU in a warehouse, distribution center or truck to be ascertained is also provided.

It is appreciated that, while in the illustrated embodiment all of the sensors are shown as individual sensors, any or all of the above sensors may be included on a single chip.

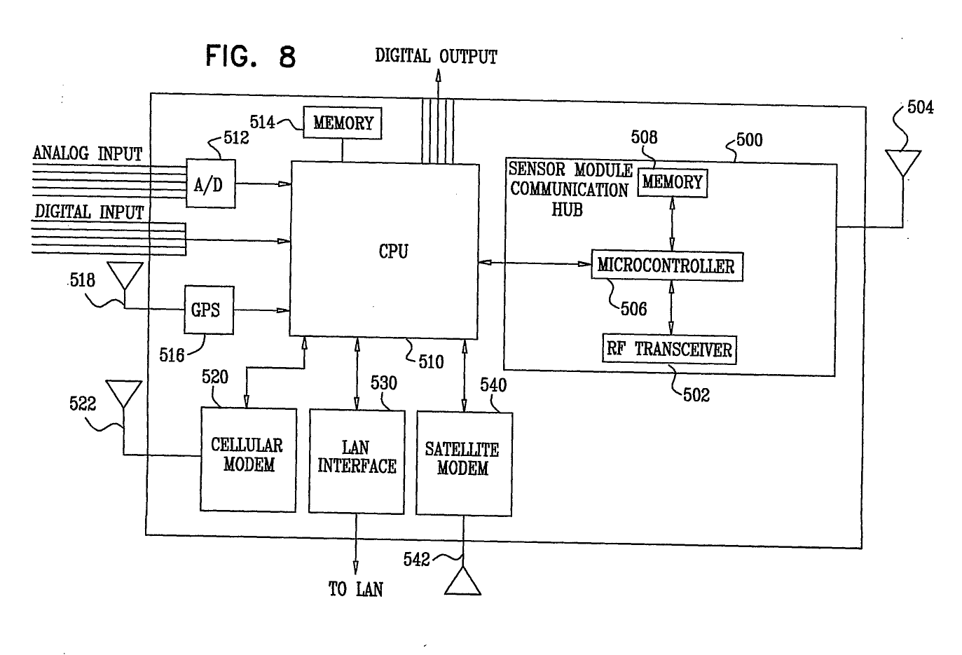

Reference is now made to FIG. 8, which is a simplified illustration of a sensed inputs integrator and communicator (SIIC), various embodiments of which are employed in the system of FIGS. 1A-1H and 2A-2C. The function of the SIIC, simply stated, is to manage bidirectional communication between the sensor modules described hereinabove, external sensors providing digital and/or analog inputs, GPS location data, and remote data analysis, processing and reporting functionality, including, inter alia, PLM 104, communication servers 106 and 112 and multiple user interfaces 110 (FIGS. 1A-1H). Such communication employs one or more of LANs, such as LAN 108, 172, 184, 191, 196, 199 and 204, a cellular network, such as GPRS, a wireless data network 107, such as a satellite communication network, and the internet.

As seen in FIG. 8, the SIIC preferably comprises a sensor module communication hub 500 which includes an RF transceiver 502 coupled to an antenna 504. A micro-controller 506 is coupled to the RF transceiver 502 to a memory 508, such as a flash memory, and via a suitable communications interface (not shown) to a CPU 510.

The functionality of sensor module communication hub 500 is preferably initially to provide an indication to the various sensor modules that a hub is present and operating and then to act an intermediary in communications with the various sensor modules. Data received from the various sensor modules is preferably stored in memory 508 and is downloaded from memory 508 in response to requests from CPU 510.

CPU 510 forms part of a remote communications manager which manages communication with external sensors providing digital and/or analog inputs, GPS location data, and remote data analysis, processing and reporting functionality, including, inter alia, PLM 104, communication servers 106 and 112 and multiple user interfaces 110 (FIGS. 1A-1H).

Communication between CPU 510 and external sensors providing digital and/or analog inputs is typically unidirectional. Similarly, communication between CPU 510 and external systems and indicators is typically unidirectional.

Examples of external sensors providing analog inputs are ambient temperature sensors indicating the ambient temperature in the vicinity of the SIIC; ambient pressure sensors, such as sensors which indicate the air pressure in the vicinity of the SIIC, which may include an indication of vacuum; relative humidity sensors, such as sensors which indicate the relative humidity in the vicinity of the SIIC; gas sensors, such as O₂, CO₂, ethanol and methyl bromide sensors; pH and other environment sensors which provide an indication of environmental conditions outside of a given MSU. Inputs from such external sensors are typically received by CPU 510 via an A/D converter 512. A memory 514 is preferably associated with CPU 510 and is operative to store data received from the external sensors.

Examples of external sensors providing digital inputs are sensors which sense a mechanical state, such as the opening of a door of a truck or container, sensors which indicate the open/closed status of a vent, light sensors; sensors which indicate operational status of a refrigeration unit; sensors indicating operational status of a vehicle engine and/or charging of a battery of a vehicle or a refrigerated container, sensors which indicate operational status of a humidifier or a dehumidifier and sensors which indicate operational status of an ozone generator. Digital inputs from such external sensors are typically received directly by CPU 510 and stored in memory 514.

Unidirectional and bi-directional interface communications, both digital and analog interfaces, between controllers of external systems and CPU 510 may also be provided.

A GPS receiver 516, associated with a GPS antenna 518 provides GPS location data to CPU 510.

A modem 520 for cellular communications is associated with an antenna 522 and enables communication between CPU 510 and remote data analysis, processing and reporting functionality, including, inter alia, PLM 104, communication servers 106 and 112 and multiple user interfaces 110 (FIGS. 1A-1H) via a cellular communications network.

A LAN interface 530 enables LAN communications between CPU 510 and remote data analysis, processing and reporting functionality, including, inter alia, PLM 104, communication servers 106 and 112 and multiple user interfaces 110 (FIGS. 1A-1H) via one or more of LANs, such as LAN 108, 172, 184, 191, 196, 199 and 204.

A satellite communications modem 540 is associated with an antenna 542 and enables satellite communications between CPU 510 and remote data analysis, processing and reporting functionality, including, inter alia, PLM 104, communication servers 106 and 112 and multiple user interfaces 110 (FIGS. 1A-1H) via a satellite communications link.

The RTC is preferably provided with rechargeable portable power functionality, such as a rechargeable battery (not shown).

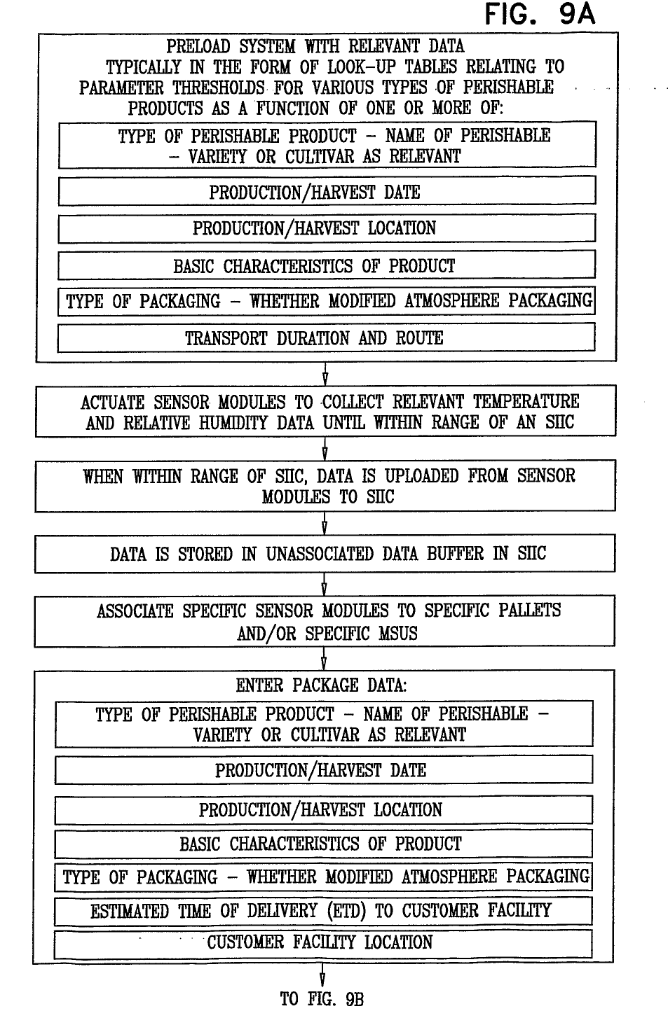

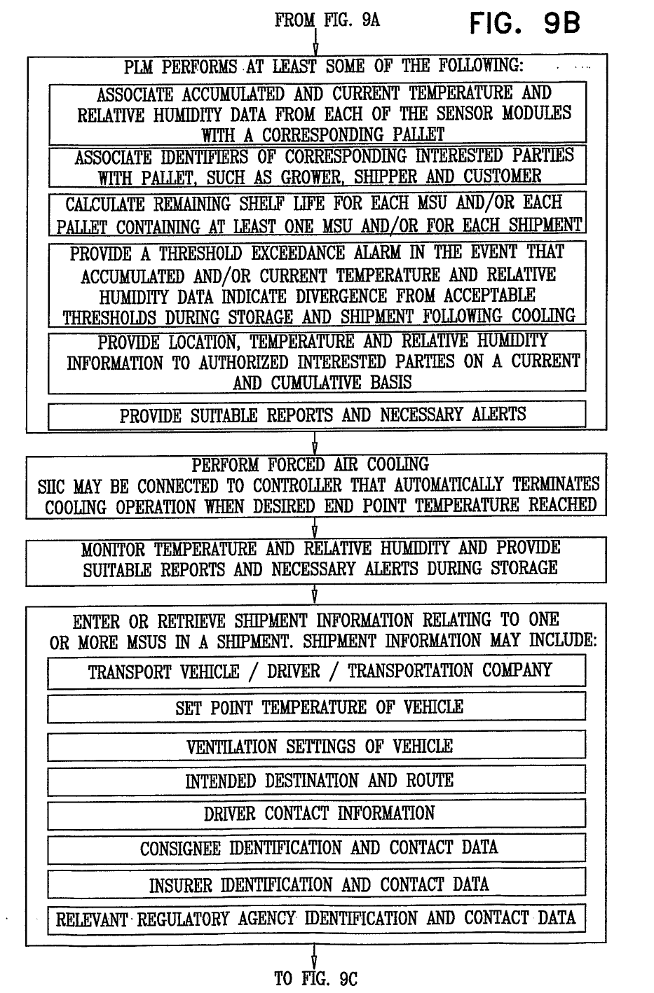

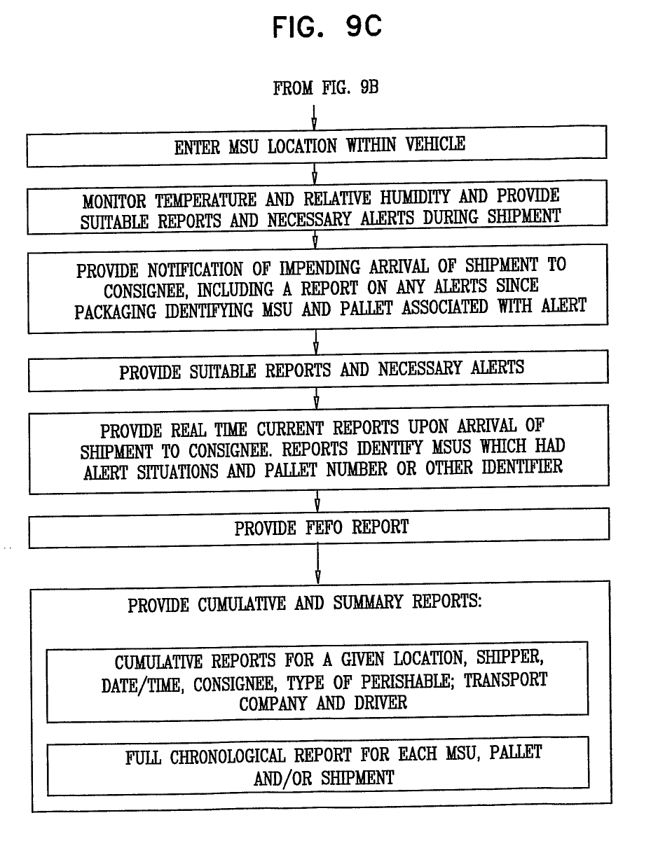

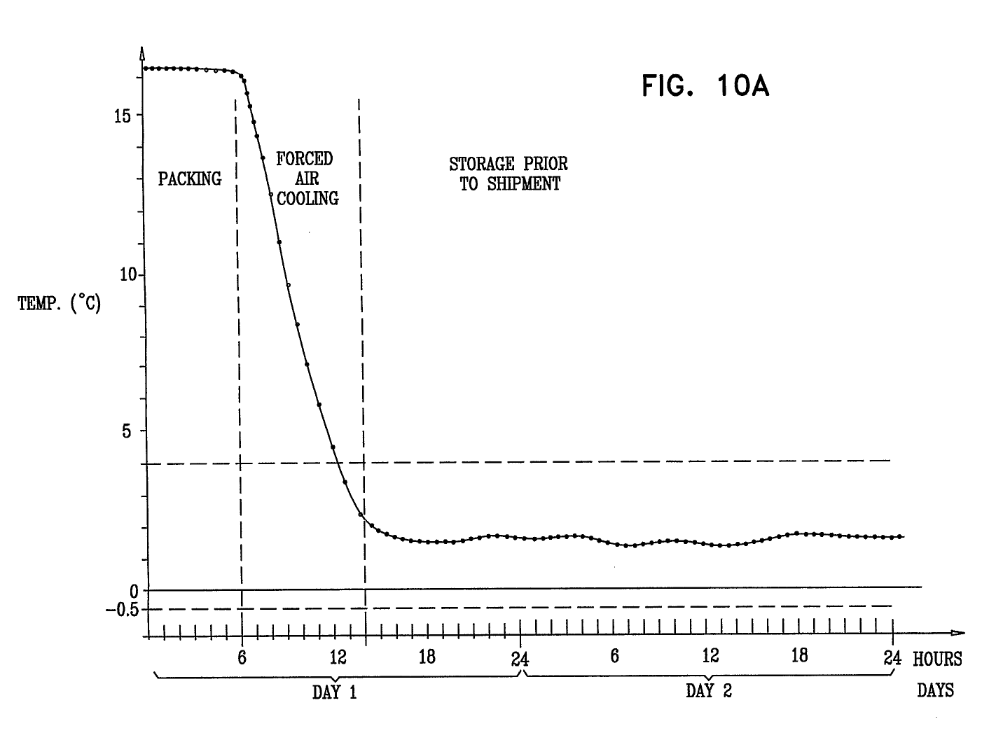

Reference is now made to FIGS. 9A-9C, which, taken together, are a simplified functional flow chart of one embodiment of the operation of the system of FIGS. 1A-1H employing the sensor of FIGS. 3-5C, and FIGS. 10A-10G, which are simplified representations of reports provided to various authorized interested parties by the system of FIGS. 1-9C.

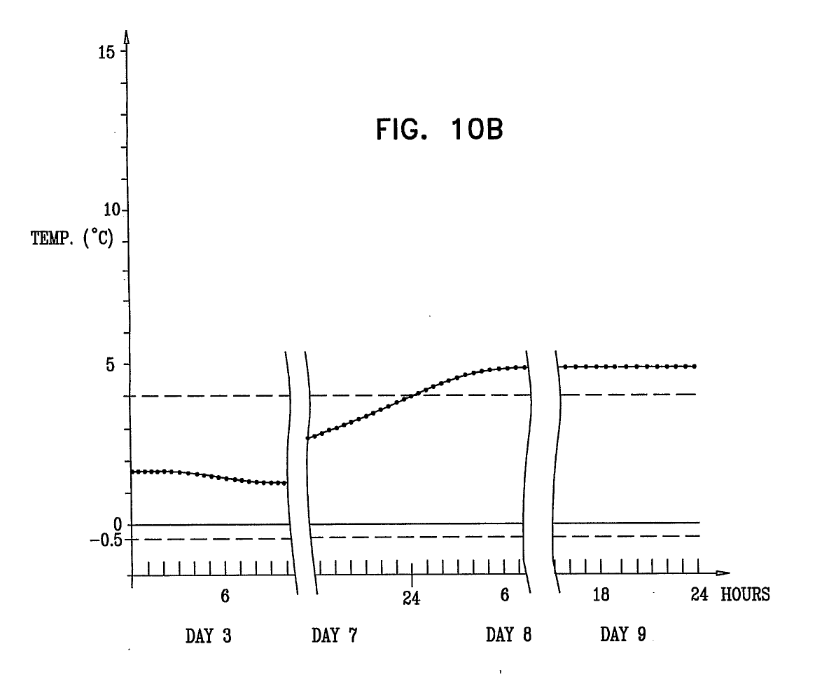

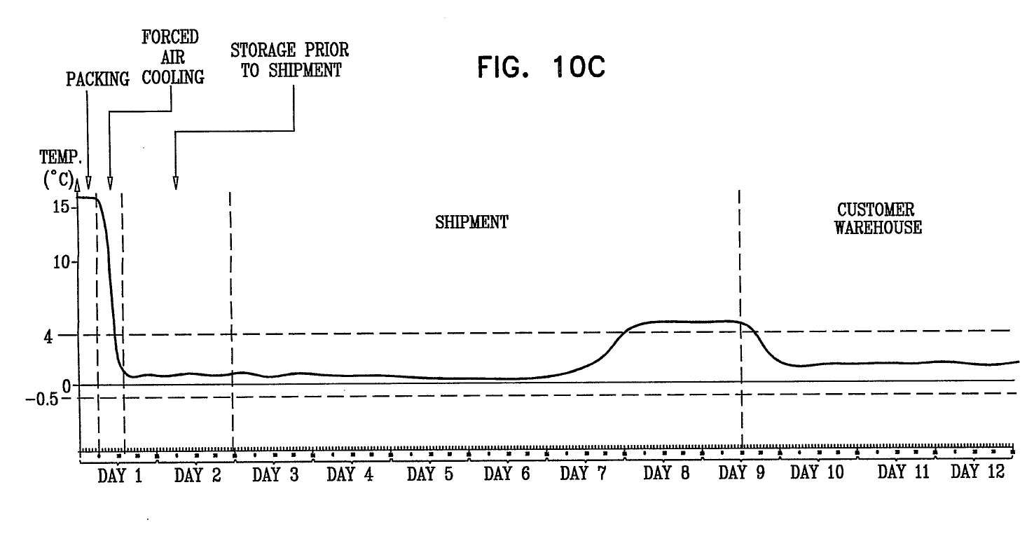

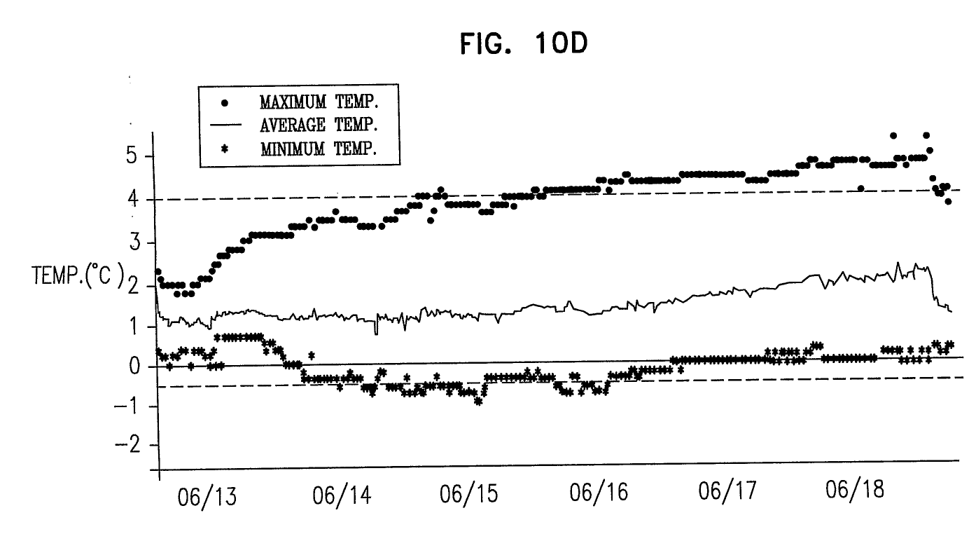

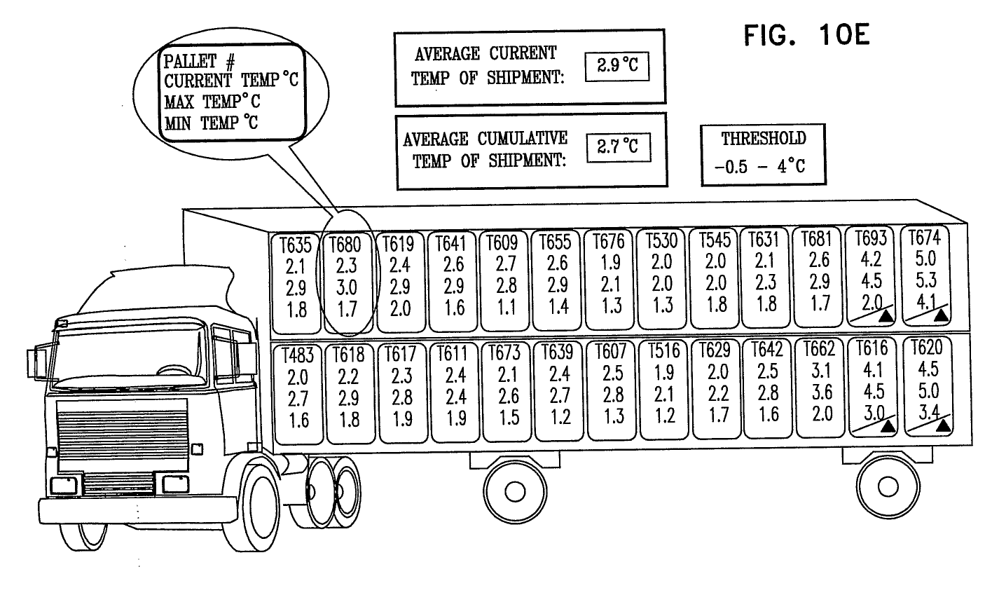

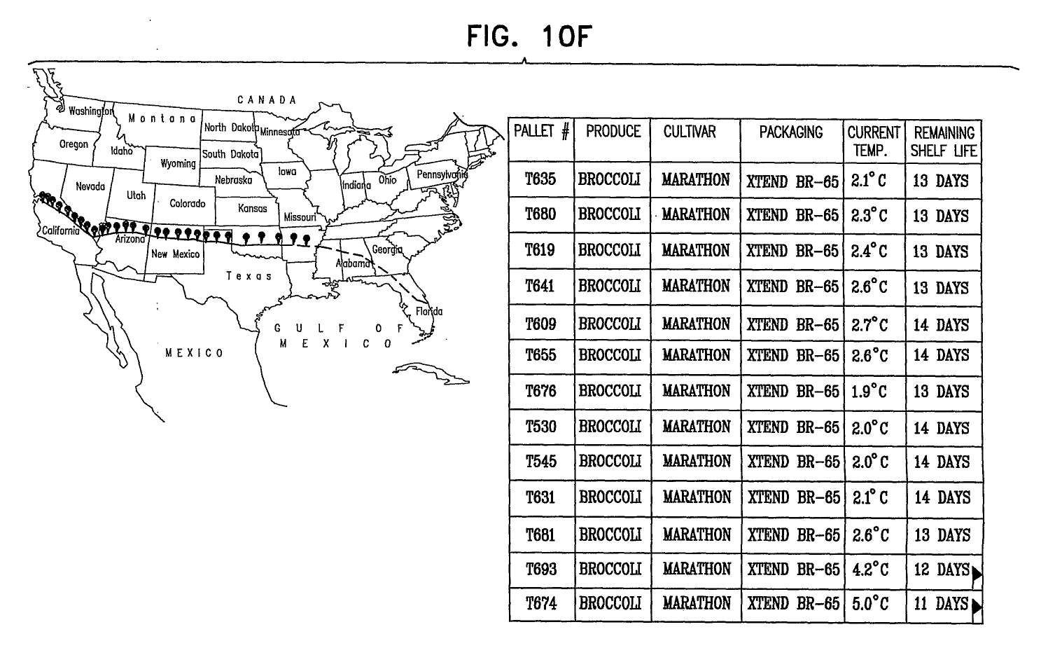

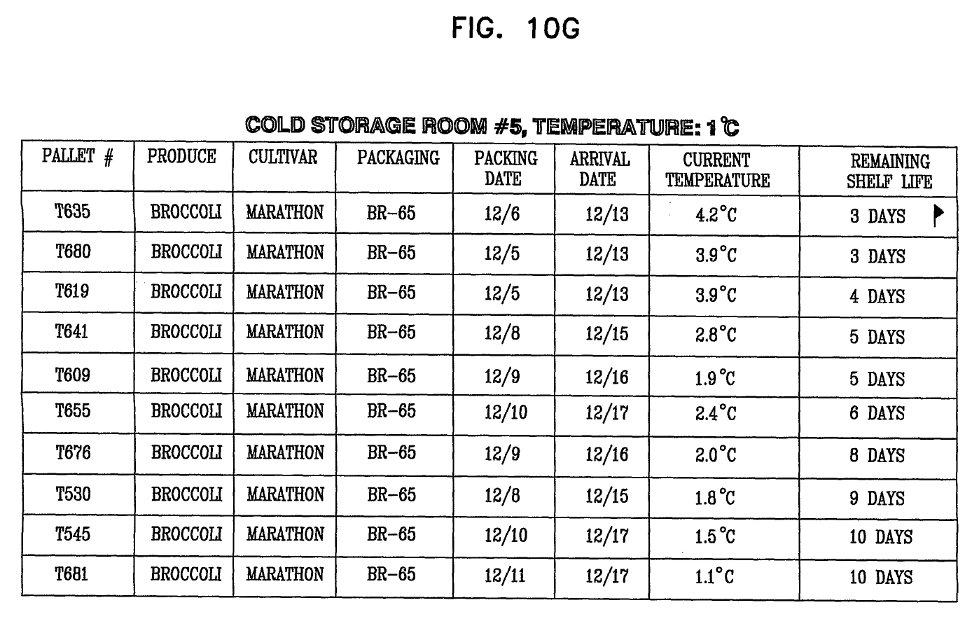

It is appreciated that, while the examples shown in FIGS. 10A-10G generally relate to the measurement of temperature, similar outputs can be provided for any measured parameter, or any combination of one or more measured parameters, by the system of the present invention.

As seen in FIGS. 9A-9C, the system is preloaded with relevant data, typically in the form of a plurality of look-up tables relating to parameter thresholds for various types of perishable products expected to be managed by the system. An example of a perishable product is broccoli, which will be referenced throughout the description of a preferred embodiment of the present invention which follows.

In this example, the broccoli is grown in the vicinity of Salinas, Calif. The cultivar may be, for example, Marathon. Broccoli is grown and harvested all year. Preferably it is packaged at the field in modified atmosphere packaging such as XTEND® BR-65 packages, commercially available from Stepac Ltd. of Tefen, Israel. Each package contains 8-10 Kg. of broccoli. The modified atmosphere packaging is preferably associated with a cardboard container of the type and in a manner described in U.S. Pat. No. 6,740,346.

Harvesting, field packaging and field palletization of the broccoli takes place near Salinas, Calif., typically out of the range of any SIIC. In the field, sensor modules 100 are actuated and placed into two packages (MSUs) per pallet, one of which is preferably located at the outside of each pallet 128 and one of which is preferably located at the inside of each pallet. At the time of actuation there is no communication between the sensor modules 100 and the remainder of the system, since actuation takes place out of range of an SIIC. It is appreciated that a single MSU or more than two MSUs may be alternatively included in each pallet. As a further alternative, not every pallet in a shipment is provided with an MSU.

The pallets typically are trucked on a non-refrigerated truck to a forced air cooling facility in Salinas. During this time, beginning from actuation, the temperature and relative humidity of the MSUs associated with the respective sensor modules are monitored and this information is logged by the sensor modules. Upon arrival at the forced air cooling facility, the sensor modules 100 establish communication with an SIIC 102 located at the forced air cooling facility and the temperature and relative humidity data logged by the sensor modules is uploaded via the SIIC 102 and typically, via LAN 108, communication server 106 and the internet to PLM 104.

Since the data has not yet been associated with a given pallet and therefore cannot be associated with a given customer, it is preferably stored by PLM 104 in an unassociated data buffer.

Preferably, association of given sensor modules with given pallets takes place at the forced air cooling facility prior to forced air cooling; as by using handheld device 150 (FIG. 1C). The association data is uploaded via the SIIC 102 and typically via LAN 108, communication server 106 and the internet to PLM 104.

At this stage, information regarding the broccoli on the pallets and the estimated time of delivery (ETD) of the broccoli to the customer facility as well as the customer facility location are either manually entered, such as via handheld device 150, or received via a computer network from another source, such as an enterprise server of a grower or packing house. The association data and the information regarding the broccoli as well as the data received from the sensor modules via the SIICs is preferably used by PLM 104 to carry out at least some of the following functions:

1. Association of the accumulated and current temperature and relative humidity data from each of the sensor modules with a corresponding pallet of broccoli and with identifiers of corresponding interested parties, such as the grower, shipper and customer.

2. Calculation of remaining shelf life for each MSU and/or for each pallet containing at least one MSU and/or for each shipment.

3. Providing a threshold exceedance alarm in the event that the accumulated and/or current temperature and relative humidity data indicate a divergence from acceptable thresholds during storage and shipment following cooling.

4. Providing location, temperature and relative humidity information on a current and cumulative basis to authorized interested parties.

Thresholds for temperature and relative humidity are normally well known and accessed by the PLM 104 from suitable databases. For broccoli in modified atmosphere packaging, optimum temperature Thresholds are 0-2° C. and temperature alerts are preferably given when three consecutive readings of below −0.5° C. or above 4° C. are received. Typical relative humidity thresholds are 90%-95% relative humidity. Divergence from the relative humidity thresholds typically indicates physical tampering with the modified atmosphere packaging.

It is appreciated that the continuous monitoring of temperature (T) and relative humidity (RH) facilitates calculation of dew point (T_{d}) according to the equation below:

$${T}_{d} = \frac{b γ ( T , RH )}{a - γ ( T , RH )}$$

$$Where \text{:}$$

$$γ ( T , RH ) = \frac{aT}{b + T} + ln ( RH / 100 )$$

Temperature is expressed in degrees Celsius and “ln” refers to the natural logarithm. The constants are:

a=17.27

b=237.7° C.

Typically, dew point alerts are given when the temperature of the air has decreased to within 0.5° C. of the dew point and condensation is likely to begin forming on the produce.

Following association of the sensor modules 100 with given pallets 128, forced air cooling preferably takes place, as seen in FIG. 1C. Preferably, one or more sensor modules 100 on each of pallets 128 provides a real-time remote indication of temperature of the broccoli. The temperature indications are preferably provided for the outside and the inside of each pallet by suitable placement of probes 134. SIIC 152 within cooling chamber 154 provides a near real time output indication of sensed temperature of the broccoli. SIIC 152 preferably outputs to cooling controller 156 which automatically terminates the cooling operation when a desired end point temperature, typically 2° C., has been reached at the inside of all of the pallets in the cooling chamber and/or provides an operator sensible indication at this stage. The temperatures and relative humidity of the broccoli sensed by sensor modules 100 during this stage are transmitted to PLM 104 by SIIC 152, which communicates with PLM 104.

The cooled produce may be stored in a cold-storage facility at a temperature of 0-2° C. prior to shipment. The temperatures and relative humidity of the broccoli sensed by sensor modules 100 during this stage are transmitted to PLM 104 by warehouse SIIC 102 which communicates with PLM 104.

The cooled produce is then loaded into a refrigerated transport vehicle, which preferably has a vehicle mounted SIIC 102 and/or a portable SIIC 161, typically including an integrated GPS locator 160, for transport to a customer. All of the sensor modules 100 currently in communication with a vehicle mounted SIIC 102 or a portable SIIC 161 are considered to belong to the same shipment.

The system becomes aware of the loading of multiple MSUs as a shipment onto a transport vehicle equipped with a vehicle mounted SIIC 102, preferably by noting three successive transmissions of data from the vehicle mounted SIIC 102.

The system also preferably retrieves shipment information relating to one or more MSUs in a shipment from an external computer system. Alternatively, the shipment information is entered into the system manually or by scanning. Examples of shipment information include identification data regarding the transport vehicle and its driver and the transportation company, the set point temperature of the transport vehicle, the ventilation settings of the transport vehicle, the intended destination and route, driver contact information, the intended destination and route, identification and contact data regarding the consignee, the insurer and any relevant regulatory agency identification and contact data.

Upon loading of the transport vehicle, the location of each MSU in the transport vehicle preferably is entered into the system as by using a portable barcode reader. A preferred barcode reader is a Portable Data Collection Terminal Input Model M3, commercially available from Mobilecompia Co. Ltd. of Korea.

It is a particular feature of the present invention that PLM 104 and possibly some or all of user interfaces 110 include functionality for drawing a clear line of demarcation between MSUs which are in storage and those which are in transport. This is preferably done by distinguishing between SIICs which are known to be fixed position SIICs and variable position SIICs, such as vehicle mounted SIICs and portable SIICs whose location changes. The monitored data received by the PLM 104 and possibly some or all of user interfaces 110 identifies the SIIC from which the data was received and thus enables the MSU sensor modules communicating with fixed position SIICs to be distinguished from MSU sensor modules communicating with variable position SIICs.

The line of demarcation between MSUs which are in storage and those which are in transport may be used to draw a line of demarcation as to which interested party has access to what monitored information. For example, a transport company may have access to monitored information of a shipment for the time period when the shipment is in transit, but may not be given access to the monitored information for other time periods. Similarly a packer may be given access to the monitored information only for the time period prior to when a shipment leaves its facility.

FIGS. 10A-10C show time lines and acceptable temperature alert thresholds for a typical shipment of broccoli. The acceptable temperature alert thresholds chosen for this example are shown by dashed lines and are −0.5 degrees C. and 4.0 degrees C. FIGS. 10A and 10B are shown on the same time scale, while FIG. 10C is shown on a more compressed time scale than that of FIGS. 10A and 10B.

For example, FIG. 10A illustrates an MSU-specific report typically received from multiple fixed position SIICs 102, which report covers a period between packing through forced air cooling and subsequent storage before loading on a refrigerated truck. This report is suitable for access by all interested parties. Typically temperature and other data relating to an MSU is sampled by a sensor module 100 associated therewith and is transmitted by a fixed position SIIC 102 every 30 minutes.

FIG. 10B illustrates an MSU-specific report received from a variable position SIIC 102, which covers a period when the broccoli is on the refrigerated truck from loading to unloading. This report may be provided to a transport company, a customer or an insurer. Typically temperature and other data relating to an MSU is sampled by the sensor module 100 associated therewith and transmitted by the variable position SIIC 102 at predetermined intervals, typically every 30 minutes. If a portable SIIC 161 is employed and operates on its own battery power, typically temperature and other data relating to an MSU is sampled by the sensor module associated with that MSU and transmitted by the portable SIIC 161 at predetermined intervals, typically every 60 minutes. FIG. 10B indicates that an overthreshold temperature alert situation first occurs at the beginning of day 8, while the shipment is enroute on the refrigerated truck.

FIG. 10C illustrates an MSU-specific report including the data contained in the reports of FIGS. 10A & 10B and also continuing through to delivery of the shipment at the customer's facility and subsequent storage in the customer's warehouse. This report may typically be provided to the customer and to an insurer. FIG. 10C shows that the produce arrived at the customer's facility in an overthreshold temperature situation and that corrective action was immediately taken at the customer's facility to cool down the produce to an acceptable temperature.

The reports exemplified in FIGS. 10A-10C are provided to authorized interested parties by PLM 104, preferably as displays on fixed or portable computers or communication devices preferably starting at the time when an SIIC is initially in communication with the sensor modules 100 and PLM 104 and continuing through transport to delivery and subsequent storage as long as the MSU remains intact and the SIIC remains in communication with sensor modules 100 and PLM 104.

During transport in a SIIC equipped transport vehicle, the various parameters of the produce are monitored by the sensor modules 100 which output information regarding these parameters via a vehicle mounted SIIC 102 to the remainder of the system. During transport and thereafter, the system of the present invention is preferably operative to provide the following perishable management reports for a given shipment, such as a shipment of broccoli:

A. A diagram, such as that shown in FIG. 10D, which indicates in near real time and cumulatively over the entire duration of the shipment, the maximum and minimum sampled temperature of any MSU in the shipment and the average sampled temperature of all of the MSUs in the shipment as well as acceptable temperature thresholds. FIG. 10D shows this data for a typical shipment of broccoli.

B. A diagram, such as that shown in FIG. 10E, showing the location of each MSU in a transport vehicle and indicating the current temperature and the maximum and minimum sampled temperature of each MSU in the shipment and the average sampled temperature of all of the MSUs in the shipment as well as acceptable temperature thresholds and an indication of whether overthreshold temperature alerts or underthreshold temperature alerts have occurred and if so, the relevant pallet numbers. FIG. 10E shows this data for a typical shipment of broccoli. The arrows indicate the occurrence of overthreshold temperature alerts. Cumulative data for each MSU may be displayed in response to a suitable mouse click. All of the data and reports described above and below in FIGS. 10A-10G may also be readily accessible by appropriate mouse clicks. MSU specific data is preferably accessed by clicking on the location of a given MSU, similarly pallet specific data is preferably accessed by clicking on the location of a given pallet.

C. A diagram, such as that shown in. FIG. 10F, overlaid on a map of the route of the shipment, the diagram indicating in near real time and cumulatively over the entire duration of the shipment, the location of the shipment and the presence or absence of any temperature alerts and corrections thereof. Preferably, the location is reported as frequently as every two hours, subject to GPS satellite availability. Alongside the diagram, a table is preferably provided indicating remaining shelf life and current temperature for each pallet, identified by one or more MSU and designated by a pallet number. Flags appear next to the rows of pallets for which alerts have been issued. Preferably, the information contained in diagrams A and B is available as a window accessible in response to a mouse click on a given item in the table.

The perishable management reports are preferably provided to the various authorized interested parties on displays associated with their computers, which may be fixed or portable.

The system preferably also provides a number of alerts. These alerts are preferably provided in near real time by the PLM 104 immediately upon receipt of overthreshold or underthreshold data for any MSU or any other information indicating a problem, such as, for example, a reduction in remaining shelf life to near or below the remaining duration of transport. The alerts preferably include an indication of the identity of the MSU and of the relevant pallet and shipment that is associated with the alert and which may require special handling.

The alerts are preferably transmitted to a cellular telephone or other portable communicator of an authorized interested party by voice, SMS or any other suitable messaging functionality as well as by pop-up messages which appear on display screens associated with computers of authorized interested parties and which may be accompanied by audio prompts. When an alert situation is encountered in a shipment having a vehicle mounted SIIC 102 or a portable SIIC 161, bluetooth or any other short-range communication may be employed to provide an alert directly from the SIIC to the vehicle driver. An alert, when received by a suitably equipped mobile communicator, may enable the user to access any of reports exemplified in FIGS. 10A-10F.

The system preferably also supplies a notification of impending arrival of a shipment to its consignee, preferably including a report on any alerts since initial packaging with an indication of the identity of the MSU and of the relevant pallet that is associated with the alert and which may require special handling. The notification is preferably provided to authorized interested parties, such as the customer and an insurance representative by voice, SMS or any other suitable messaging functionality as well as by pop-up messages which appear on display screens associated with computers of authorized interested parties and which may be accompanied by audio prompts. For example, as shown in FIG. 10C, when the produce arrives to the customer's warehouse in an overthreshold temperature condition, a suitable alert notification is provided and in the illustrated cases, results in immediate corrective action.

Upon arrival of a shipment to its consignee the system preferably provides near real time current reports which are accessible to consignee personnel who physically receive the shipment. These reports preferably identify any MSUs which encountered alert situations and corresponding pallet numbers or other identifiers which enable consignee personnel to immediately identify the relevant pallets and provide whatever special handling is required, such as immediate cooling, heating or rejection of a pallet. These reports also may be used to enable consignee personnel or on site insurance adjusters to quickly identify pallets requiring visual inspection.

Once the MSUs have arrived at a customer's facilities and perhaps even before, a FEFO report, such as that shown in FIG. 10G, is made available at all times to enable First Expired, First Out (FEFO) perishable management. As seen in FIG. 10G, the FEFO report preferably indicates a remaining lifetime and a current temperature for each pallet and preferably also indicates the type and variety of produce in each pallet as well as the packing date and arrival date thereof and the type of modified atmosphere packaging employed. Flags appear next to the rows of pallets for which alerts have been issued.

It is appreciated that the FEFO report may also be provided at other points in the supply chain to facilitate selection of appropriately cooled produce.

Some or all of the information appearing in any of the reports exemplified in FIGS. 10A-10G is preferably accessible by a user clicking on the relevant pallet number.

The system preferably also provides a number of cumulative and summary reports such as, for example,

I. Cumulative reports for a given location, shipper, date/time, consignee, type of perishable; transport company and driver which contain summaries and analysis of the information provided in any one or more of the reports exemplified in FIGS. 10A-10G. Such reports enable authorized interested parties to identify trends or patterns of underperformance.

II. A full chronological report for each MSU, pallet and/or shipment: Such reports enable authorized interested parties to focus on problems in a given MSU, pallet and/or shipment at any stage of the supply chain.

A number of different remaining shelf life determinations may be provided and used by the system. An example is presented hereinbelow:

The maximum time that fresh produce can be stored in modified atmosphere packaging (t_{T}) at constant temperature (T_{c}) before it reaches a threshold quality below which it is no longer saleable (Q_{threshold}) can in certain instances be calculated using the full quadratic equation 1:

Q_{threshold}=a₁+a₂(t_{T})+a₃T_{c}+a₄(t_{T})²+a₅(T_{c})² 1.

Where a1-a5 are produce specific coefficients. The values of coefficients a1-a5 and Q_{threshold} for broccoli, cultivar (cv.) marathon, stored in XTEND® BR-65 modified atmosphere/modified humidity packaging are:

a₁=5.327

a₂=0.06002

a₃=−0.15889

a₄=−0.00182

a₅=0.003967

Q_{threshold}=2

These values were determined empirically after studying the influence of both temperature and time on the deterioration in quality of broccoli, cv. marathon, stored in XTEND® BR-65 and then conducting pure quadratic analysis of the obtained data. Of the measured parameters, that which best represented the deterioration in quality was a qualitative estimation of the overall quality using an arbitrary scale, in which a score of 2 or below was deemed as non-saleable.

Employing equation 1, the maximum time that broccoli, cv. marathon, can be stored in XTEND® BR-65 (t_{T}) at constant temperature (T_{c}) of 1° C. is 28 days:

2=5.327+(−0.06002t_{T})+−0.15889(1)+−0.00182(t_{T})²+0.003967(1)²

t_{T}=28 days at 1° C.

The remaining time that fresh produce can be stored in modified atmosphere packaging under non-isothermal conditions before it is no longer saleable (RTMANLS) can be calculated using the following equation:

RTMANLS=t_{T}−t_{eq}

where t_{eq} is the time required to reach current quality (Q_{N}) if the produce were stored at constant storage temperature Tc and can be calculated using Equation 2.

Q_{N}=a₁+a₂(t_{eq})+a₃T_{c}+a₄(t_{eq})²+a₅(T_{c})² 2.

Q_{N} (where N is an integer representing the numbered time interval) is determined as follows:

Under non-isothermal conditions, it is assumed that there are N time-temperature intervals. The temperature in the first time-temperature interval (Δt₁=t₁−t₀) is T₁ and in the Nth time-temperature interval (Δt_{N}=t_{N}−t_{N-1}) is T_{N}. The quality of the produce at the end of the first time interval (Q₁) is determined using equation 3:

Q₁=a₁+a₂(Δt₁)+a₃T₁+a₄(Δt₁)²+a₅(T₁)² 3.

For instance, after t=6 days at t=1° C. in XTEND® BR-65, the remaining quality of: broccoli, cv. marathon, would be:

Q₁=5.327+−0.06002(6)+−0.15889(1)+−0.001827(6)²+0.003967(1)²=4.746

RTMANLS at this stage=28−6=22 days at 1° C.

The time required to reach current quality Q₁ at the temperature of the next time-temperature interval (T₂) is t_{1eq} and is determined using equation 4, which is essentially identical to equation 2:

Q₁=a₁+a₂(t_{1eq})+a₃T₂+a₄(t_{1eq})²+a₅(T₂)² 4.

If the broccoli in the current example is subsequently exposed to T=3° C. for 2 days, then first of all, the time required to reach the current quality of 4.746 at 3° C. is calculated using equation 4:

4.746=5.327+−0.06002(t_{1eq})+−0.15889(3)+−0.001827(t_{1eq})²+0.003967(3)²

t_{1eq}=2.18 days

The quality of the produce at the end of the 2nd time-temperature interval is Q₂ and is calculated using equation 5:

Q₂=f₁(t_{1eq}+Δt₂, T₂)=a₁+a₂(t_{1eq}+Δt₂)+a₃T₂+a₄(t_{1eq}+Δt₂)²+a₅(T₂)² 5.

The quality of the broccoli in the current example after exposure to 3° C. for 2 days is therefore:

Q₂=5.327+−0.06002(2.18+2)+−0.15889(3)+−0.001827(2.18+2)²+0.003976(3)²=4.603

Equations 4 and 5 are used to calculate the remaining quality after further time-temperature intervals. For instance, if the broccoli in the current example is exposed to T=5° C. for 2 days, the time required to reach the current quality of 4.603 at 5° C. (t_{2eq}):

4.603=5.327+−0.06002(t_{2eq})+−0.15889(5)+−0.001827(t_{2eq})²+0.003967(5)²

T_{2eq}=0.472 days

The quality after 2 days at 5° C. is then calculated by employing equation 5:

Q₃=5.327+−0.06002(0.472+2)+−0.15889(5)+−0.001827(0.472+2)²+0.003967(5)²=4.472

It is clear that at any moment in time RTMANLS can be calculated for any temperature (Tc). For instance, the RTMANS of the broccoli in the current example could be calculated as follows:

The time required to reach the current quality of 4.472 at 1° C. (t_{eq}) is:

4.472=5.327+−0.06002(t_{1eq})+−0.15889(1)+−0.001827(t_{eq})²+0.003967(1)²=9 days

And the resulting RTMANLS at 1° C. is calculated as:

RTMANLS=t_{T}−t_{eq}=28−9=19 days. at 1° C.

It will be appreciated by persons skilled in the art that the present invention is not limited by what has been particularly shown and described hereinabove. Rather the present invention includes both combinations and subcombinations of various features described herein and improvements and variations which would occur to persons skilled in the art upon reading the foregoing description and which are not in the prior art.

1. A system for managing perishables in a supply chain, the system comprising:
at least one sensor module adapted to sense at least one parameter of at least one monitorable shipping unit of perishables through multiple stages in a supply chain;
a plurality of sensed inputs integrator and communicators (SIICs), each communicating with said least one sensor module at at least one different one of said multiple stages in said supply chain, for receiving information relating to said at least one parameter;
a perishable lifecycle manager (PLM) communicating with at least some of said plurality of SIICs and including at least one of remaining lifetime prediction functionality, supply chain link accountability functionality and first expired, first out logistics functionality operating using at least one parameter of at least one monitorable shipping unit of perishables through said multiple stages in said supply chain; and
a user interface providing to a user an indication of at least one of remaining lifetime prediction, supply chain link accountability and first expired, first out logistics outputs relating to said at least one monitorable shipping unit of perishables whose said at least one parameter is sensed by said at least one sensor module.

2. A system for managing perishables in a supply chain according to claim 1 and wherein:
said perishables in said least one monitorable shipping unit of perishables are packed in modified atmosphere packaging; and
said user interface provides to said user an indication of remaining lifetime prediction for said perishables which prediction is based on their being packed in said modified atmosphere packaging.

3. A system for managing perishables in a supply chain, the system comprising:
at least one sensor module adapted to sense at least one parameter of at least one monitorable shipping unit of perishables packed in modified atmosphere packaging through multiple stages in a supply chain, said at least one parameter having enhanced importance for perishables packed in modified atmosphere packaging;
a plurality of sensed inputs integrator and communicators (SIICs), each communicating with said least one sensor module at at least one different one of said multiple stages in said supply chain, for receiving information relating to said at least one parameter;
a perishable lifecycle manager (PLM) communicating with at least some of said plurality of SIICs and including at least one of remaining lifetime prediction functionality, supply chain link accountability functionality and first expired, first out logistics functionality operating using at least one parameter of at least one monitorable shipping unit of perishables through said multiple stages in said supply chain; and
a user interface providing to a user an indication of at least one of remaining lifetime prediction, supply chain link accountability and first expired, first out logistics outputs relating to said at least one monitorable shipping unit of perishables whose said at least one parameter is sensed by said at least one sensor module.

4. A system for managing perishables in a supply chain according to claim 3 and wherein said user interface distinguishes between monitorable shipping units which are in transit and monitorable shipping units which are being stored in a warehouse.

5. (canceled)

6. A system for managing perishables in a supply chain according to claim 3 and wherein said user interface provides a near real time alert when a predicted remaining lifetime of said perishable falls below a threshold.

7. A system for managing perishables in a supply chain according to claim 3 and also comprising a location indicator indicating the location of said at least one monitorable shipping unit of perishables.

8. A system for managing perishables in a supply chain according to claim 3 and wherein said user interface provides a near real time alert when a predicted remaining lifetime of said perishable falls below expected remaining transport time.

9. A system for managing perishables in a supply chain, the system comprising:
at least one sensor module adapted to sense at least one parameter of at least one monitorable shipping unit of perishables through multiple stages in a supply chain;
a plurality of sensed inputs integrator and communicators (SIICs), each communicating with said least one sensor module at at least one different one of said multiple stages in said supply chain, for receiving information relating to said at least one parameter; and
an at least near real time alert interface providing to a user an at least near real time alert of the occurrence of an event, indicated by said at least one sensor modules which is expected to impact on at least one of remaining lifetime prediction, supply chain link accountability and first expired, first out logistics.

10. A system for managing perishables in a supply chain according to claim 9 and wherein:
said perishables in said least one monitorable shipping unit of perishables are packed in modified atmosphere packaging; and
said at least near real time alert interface provides to said user an indication of remaining lifetime prediction for said perishables which prediction is based on their being packed in said modified atmosphere packaging.

11. A system for managing perishables in a supply chain according to claim 10 and wherein said at least near real time alert interface distinguishes between monitorable shipping units which are in transit and monitorable shipping units which are being stored in a warehouse.

12. A system for managing perishables in a supply chain, the system comprising:
at least one sensor module adapted to sense at least one parameter of at least one monitorable shipping unit of perishables packed in modified atmosphere packaging through multiple stages in a supply chain, said at least one parameter having enhanced importance for perishables packed in modified atmosphere packaging;
a plurality of sensed inputs integrator and communicators (SIICs), each communicating with said least one sensor module at at least one different one of said multiple stages in said supply chain, for receiving information relating to said at least one parameter; and
an at least near real time alert interface providing to a user an at least near real time alert of the occurrence of an event, indicated by said at least one sensor modules which is expected to impact on at least one of remaining lifetime prediction, supply chain link accountability and first expired, first out logistics.

13. A system for managing perishables in a supply chain according to claim 12 and also comprising temperature mapping functionality communicating with at least one of said plurality of SIICs and being operative to ascertain variations in temperature of said perishables within a volume containing multiple perishables and multiple ones of said plurality of sensor modules based on said information relating to said parameters.

14-17. (canceled)

18. A system for managing perishables in a supply chain according to claim 3 and wherein said plurality of SIICs each provide an output indication of the possible presence of at least one pathogen.

19. (canceled)

20. A system for managing perishables in a supply chain, the system comprising:
a plurality of sensor modules adapted to sense parameters of perishables in a supply chain which indicate the presence of pathogens;
at least one sensed inputs integrator and communicator (SIIC), communicating with said plurality of sensor modules, for receiving information relating to said parameters; and
an at least near real time alert interface providing to a user an at least near real time alert of the presence or expectation of the presence of at least a predetermined amount of said pathogens in a perishable whose parameters are sensed by at least one of said plurality of sensor modules.

21. A system for managing perishables in a supply chain, the system comprising:
a plurality of sensor modules adapted to sense parameters of at least one of temperature, relative humidity, ethylene, oxygen and CO₂ within modified atmosphere packaging containing perishables;
at least one sensed inputs integrator and communicator (SIIC), communicating with said plurality of sensor modules, for receiving information relating to said at least one of temperature, relative humidity, ethylene, oxygen and CO₂ parameters; and
an at least near real time alert interface providing to a user an at least near real time alert of the occurrence of exceedance of a threshold of at least one of temperature, relative humidity, ethylene, oxygen and CO₂, indicated by at least one of said plurality of sensor modules.

22-26. (canceled)

27. A system for managing perishables in a supply chain according to claim 1 and wherein said at least one sensor module includes at least one of a temperature sensor, a relative humidity sensor, an O₂ sensor, a CO₂ sensor, a C₂H₄ sensor, a C₂H₅OH sensor, a pathogen sensor and a light sensor.

28. A system for managing perishables in a supply chain according to claim 1 and wherein said at least one sensor module also comprises a GPS antenna.

29. A system for managing perishables in a supply chain according to claim 1 and wherein each of said plurality of SIICs includes at least one of an RF transceiver coupled to an antenna, a GPS receiver associated with a GPS antenna, a cellular communications modem associated with an antenna, a LAN interface and a satellite communications modem associated with an antenna.

30. A system for managing perishables in a supply chain according to claim 1 and wherein each of said plurality of SIICs includes a memory operative to store data received from at least one of said at least one sensor modules.

31. A system for managing perishables in a supply chain according to claim 1 and wherein each of said plurality of SIICs communicates with external sensors including at least one of an ambient temperature sensor, an ambient pressure sensor, a relative humidity sensor, at least one gas sensor, pH sensor, a door opening sensor, an open/closed vent sensor, a light sensor; a refrigeration unit status sensor; a vehicle engine status sensor, a vehicle battery charging sensor, a refrigerated container battery charging sensor, a humidifier status sensor, a dehumidifier status sensor and an ozone generator status sensor.

32. A system for managing perishables in a supply chain according to claim 31 and wherein said at least one gas sensor comprises at least one of an O₂ sensor, a CO₂ sensor, an ethanol sensor and a methyl bromide sensor.

33. A system for managing perishables in a supply chain according to claim 1 and wherein said plurality of SIICs includes at least one fixed position SIIC and at least one variable position SIIC.

34. A system for managing perishables in a supply chain according to claim 1 and wherein said user interface is operative to provide access to different system information to different system users.

35. A system for managing perishables in a supply chain according to claim 1 and wherein said PLM is operative to provide an advance notification of impending arrival of distressed perishables.

36. A method for managing perishables in a supply chain, the method comprising:
sensing at least one parameter of at least one monitorable shipping unit of perishables through multiple stages in a supply chain;
employing a plurality of sensed inputs integrator and communicators (SIICs), each communicating with at least one sensor module at at least one different one of said multiple stages in said supply chain, for receiving information relating to said at least one parameter;
communicating with at least some of said plurality of SIICs and producing, based on information received therefrom, at least one of remaining lifetime predictions, supply chain link accountability information and first expired, first out logistics information through multiple stages in said supply chain; and
providing to a user at least one of remaining lifetime prediction, supply chain link accountability information and first expired, first out logistics outputs relating to said at least one monitorable shipping unit of perishables whose said at least one parameter is sensed by said at least one sensor module.

37. A method for managing perishables in a supply chain according to claim 36 and wherein:
said perishables in said least one monitorable shipping unit of perishables are packed in modified atmosphere packaging; and
said providing to a user comprises providing an indication of remaining lifetime prediction for said perishables based on their being packed in said modified atmosphere packaging.

38. A method for managing perishables in a supply chain, the method comprising:
sensing at least one parameter of at least one monitorable shipping unit of perishables packed in modified atmosphere packaging through multiple stages in a supply chain, said at least one parameter having enhanced importance for perishables packed in modified atmosphere packaging;
employing a plurality of sensed inputs integrator and communicators (SIICs), each communicating with at least one sensor module at at least one different one of said multiple stages in said supply chain, for receiving information relating to said at least one parameter;
communicating with at least some of said plurality of SIICs and producing, based on information received therefrom, at least one of remaining lifetime predictions, supply chain link accountability information and first expired, first out logistics information through multiple stages in said supply chain; and
providing to a user at least one of remaining lifetime prediction, supply chain link accountability information and first expired, first out logistics outputs relating to said at least one monitorable shipping unit of perishables whose said at least one parameter is sensed by said at least one sensor module.

39. A method for managing perishables in a supply chain according to claim 36 and wherein said providing to a user comprises distinguishing between monitorable shipping units which are in transit and monitorable shipping units which are being stored in a warehouse.

40. (canceled)

41. A method for managing perishables in a supply chain according to claim 36 and also comprising providing a near real time alert when a predicted remaining lifetime of said perishable falls below a threshold.

42. A method for managing perishables in a supply chain according to claim 36 and also comprising monitoring the location of said at least one monitorable shipping unit of perishables.

43. A method for managing perishables in a supply chain according to claim 36 and also comprising providing a near real time alert when a predicted remaining lifetime of said perishable falls below expected remaining transport time.

44. A method for managing perishables in a supply chain, the method comprising:
sensing at least one parameter of at least one monitorable shipping unit of perishables through multiple stages in a supply chain;
employing a plurality of sensed inputs integrator and communicators (SIICs), each communicating with at least one sensor module at at least one different one of said multiple stages in said supply chain, for receiving information relating to said at least one parameter; and
providing to a user an at least near real time alert of the occurrence of an event, indicated by said sensing, which is expected to impact on at least one of remaining lifetime prediction, supply chain link accountability and first expired, first out logistics.

45-46. (canceled)

47. A method for managing perishables in a supply chain, the method comprising:
sensing at least one parameter of at least one monitorable shipping unit of perishables packed in modified atmosphere packaging through multiple stages in a supply chain, said at least one parameter having enhanced importance for perishables packed in modified atmosphere packaging;
employing a plurality of sensed inputs integrator and communicators (SIICs), each communicating with at least one sensor module at at least one different one of said multiple stages in said supply chain, for receiving information relating to said at least one parameter; and
providing to a user an at least near real time alert of the occurrence of an event, indicated by said sensing, which is expected to impact on at least one of remaining lifetime prediction, supply chain link accountability and first expired, first out logistics.

48. A method for managing perishables in a supply chain according to claim 36 and also comprising:
communicating with at least one of said plurality of SIICs; and
ascertaining variations in temperature of said perishables within a volume containing multiple perishables and multiple ones of said plurality of sensor modules based on said information relating to said parameters.

49-52. (canceled)

53. A method for managing perishables in a supply chain according to claim 36 and also comprising providing an output indication of the possible presence of at least one pathogen.

54. A method for managing perishables in a supply chain according to claim 36 and also comprising providing an output indication of the possible presence of at least one of ethylene, ethanol, oxygen and CO₂.

55. A method for managing perishables in a supply chain, the method comprising:
sensing, with a plurality of sensor modules, parameters of perishables in a supply chain which indicate the presence of pathogens;
employing a plurality of sensed inputs integrator and communicators (SIICs), receiving information relating to said parameters from said plurality of sensor modules; and
providing to a user an at least near real time alert of the presence or expectation of the presence of at least a predetermined amount of said pathogens in a perishable whose parameters are sensed by at least one of said plurality of sensor modules.

56. A method for managing perishables in a supply chain, the method comprising:
sensing, with a plurality of sensor modules, parameters of at least one of temperature, relative humidity, ethylene, oxygen and CO₂ within modified atmosphere packaging containing perishables;
employing a plurality of sensed inputs integrator and communicators (SIICs), receiving information relating to said at least one of temperature, relative humidity, ethylene, oxygen and CO₂ parameters from said plurality of sensor modules; and
providing to a user an at least near real time alert of the occurrence of exceedance of a threshold of at least one of temperature, relative humidity, ethylene, oxygen and CO₂, indicated by at least one of said plurality of sensor modules.

57-60. (canceled)

61. A method for managing perishables in a supply chain according to claim 36 and also comprising communicating a time stamp related to said at least one parameter to said SIIC.

62. A method for managing perishables in a supply chain according to claim 36 and wherein said at least one parameter includes at least one of temperature, relative humidity, O₂ level, CO₂ level, C₂H₄ level, C₂H₅OH level, pathogen level and light level.

63-70. (canceled)

71. A system for managing perishables in a supply chain according to claim 1 and wherein said user interface distinguishes between monitorable shipping units which are in transit and monitorable shipping units which are being stored in a warehouse.

72. A system for managing perishables in a supply chain according to claim 1 and wherein said user interface provides a near real time alert when a predicted remaining lifetime of said perishable falls below a threshold.

73. A system for managing perishables in a supply chain according to claim 1 and also comprising a location indicator indicating the location of said at least one monitorable shipping unit of perishables.

74. A system for managing perishables in a supply chain according to claim 1 and wherein said user interface provides a near real time alert when a predicted remaining lifetime of said perishable falls below expected remaining transport time.

75. A system for managing perishables in a supply chain according to claim 1 and wherein said plurality of SIICs each provide an output indication of the possible presence of at least one pathogen.
